(19) United States
(12) Patent Application Publication
(10) Pub. No.: US 2026/0073315 A1
(43) Pub. Date: Mar. 12, 2026

(54) COMPUTER SYSTEMS AND METHODS FOR EXPLAINING PREDICTIONS OF MACHINE-LEARNING MODELS

(71) Applicant: Capital One Financial Corporation, McLean, VA (US)

(72) Inventors: Ashkan Golgoon, Glenview, IL (US); Khashayar Filom, Chicago, IL (US); Arjun Ravi Kannan, Buffalo Grove, IL (US)

(21) Appl. No.: 18/883,374

(22) Filed: Sep. 12, 2024

(51) Int. Cl. G06Q 10/04

(52) U.S. Cl. CPC G06Q 10/04

(57) ABSTRACT

A computing platform may be configured to: (i) perform a plurality of explanation runs for explaining a prediction rendered by a machine learning model, where each explanation run involves (1) identifying (a) a first local search space for a model-feature explanation component, (b) a second local search space for a subgraph explanation component, and (c) a third local search space for a nodal-feature explanation component, (2) navigating the first, second, and third local search spaces to determine a respective candidate explanation that satisfies an explanation rule, and (3) determining a respective explanation score for the respective candidate explanation; and (ii) based on the respective explanation scores for the respective candidate explanations, determine a given explanation for the prediction including a given subset of a set of model features, a given subgraph of a data graph, and a given subset of a set of nodal features.

### BACKGROUND

Organizations in many different industries have begun to operate computing platforms that are configured to ingest, process, analyze, generate, store, and/or output data that is relevant to the businesses of those organizations. Such computing platforms are often referred to as “data platforms.” For example, a financial institution may operate a data platform that is configured to ingest, process, analyze, generate, store, and/or output data related to the financial institution's customers and their financial accounts, such as financial transactions data (among other types of data that may be relevant to the financial institution's business). As another example, an organization interested in monitoring the state and/or operation of physical objects such as industrial machines, transport vehicles, and/or other Internet-of-Things (IoT) devices may operate a data platform that is configured to ingest, process, analyze, generate, store, and/or output data related to those physical objects of interest. As another example, a provider of a Software-as-a-Service (SaaS) application may operate a data platform that is configured to ingest, process, analyze, generate, store, and/or output data that is created in connection with that SaaS application. Many other examples are possible as well.

Data platforms such as these may provide several benefits to organizations, including but not limited to enabling organizations to achieve efficiencies in data management and analysis and enabling organizations to unlock the value of their data in ways not previously possible, which may lead to more informed business decisions and new business opportunities. Data platforms may provide various other advantages as well.

### Overview

Disclosed herein is software technology that improves the interpreting of predictions of machine-learning models that utilize both embeddings (e.g., neural graph embeddings) and other features as inputs.

In one aspect, the disclosed technology may take the form of a computer-implemented method carried out by a computing platform that involves: (i) performing a plurality of explanation runs for explaining a prediction rendered by a machine learning model that is configured to receive, as input, (a) an embedding produced by a graph-based model based on a data graph comprising nodes interconnected by edges, wherein the nodes are associated with values for a set of nodal features, and (b) a set of model features, wherein each explanation run involves: (1) identifying (a) a first local search space for a model-feature explanation component that identifies a subset of the set of model features, (b) a second local search space for a subgraph explanation component that identifies a subgraph of the data graph, and (c) a third local search space for a nodal-feature explanation component that identifies a subset of the set of nodal features; (2) navigating the first, second, and third local search spaces to determine a respective candidate explanation that satisfies an explanation rule, wherein the respective candidate explanation comprises (a) a respective subset of the set of model features, (b) a respective subgraph of the data graph, and (c) a respective subset of the set of nodal features; and (3) determining a respective explanation score for the respective candidate explanation; (ii) based on the respective explanation scores for the respective candidate explanations, determining a given explanation for the prediction comprising a given subset of the set of model features, a given subgraph of the data graph, and a given subset of the set of nodal features; and (iii) transmitting, to a consumer system, data defining the given explanation and thereby causing an indication of the given explanation to be presented at a user interface of the consumer system.

In an example, the explanation rule limits a size of an explanation for the prediction.

In an example, navigating the first, second, and third local search spaces to determine the respective candidate explanation that satisfies the explanation rule comprises performing a plurality of navigation episodes, wherein each navigation episode comprises the steps of: (i) selecting a given local search space for the navigation episode from the first, second, and third local search spaces, wherein the given local search space corresponds to a given explanation component from the model-feature explanation component, the subgraph explanation component, and the nodal-feature explanation component; (ii) identifying a node within the given local search space representing a current value of the given explanation component and designating the node as a starting node; (iii) determining a plurality of child nodes for the starting node; (iv) determining a respective reward value for each child node in the determined plurality of child nodes; (v) selecting the child node having a highest respective reward value as a winning node from the plurality of child nodes; (vi) evaluating whether a navigation budget has been reached for the given navigation episode; and (vii) based on the evaluating, either: (1) determining that the navigation budget has not been reached for the navigation episode and then carrying out a next iteration of steps (iii)-(vi) using the winning node as a starting node for the next iteration, or (2) determining that the navigation budget has been reached for the navigation episode and then designating the winning node from the most-recent iteration as an ending node for the navigation episode and updating the current value of the given explanation component to be the value represented by the ending node of the navigation episode.

In an example, the navigation budget is a navigation-episode depth of a given number of levels of a Monte Carlo search tree associated with the local search space.

In an example, selecting the given local search space for the navigation episode comprises selecting the given local search space for the navigation episode based on a determination of which of the first, second, and third local search spaces is expected to provide a higher expected reward.

In an example, determining the plurality of child nodes for the starting node comprises sampling a subset of all possible child nodes for the starting node to determine the plurality of child nodes.

In an example, determining the respective explanation score for the respective candidate explanation comprises determining the respective explanation score based on (i) a first importance score determined for the model-feature explanation component, (ii) a second importance score determined for the subgraph explanation component, and (iii) a third importance score determined for the nodal-feature explanation component.

In an example, (i) the first importance score determined for the model-feature explanation component comprises a first Shapley value for the model-feature explanation component, (ii) the second importance score determined for the subgraph explanation component comprises a second Shapley value for the subgraph explanation component, and (iii) the third importance score determined for the nodal-feature explanation component comprises a third Shapley value for the nodal-feature explanation component.

In another aspect, disclosed herein is a computing platform that includes at least one network interface, at least one processor, at least one non-transitory computer-readable medium, and program instructions stored on the at least one non-transitory computer-readable medium that, when executed by the at least one processor, cause the computing platform to carry out the functions disclosed herein, including but not limited to the functions of the foregoing method.

For instance, in an example, a computing platform comprises: a communication interface; at least one processor; at least one non-transitory computer-readable medium; and program instructions stored on the at least one non-transitory computer-readable medium that, when executed by the at least one processor, cause the computing platform to: (i) perform a plurality of explanation runs for explaining a prediction rendered by a machine learning model that is configured to receive, as input, (a) an embedding produced by a graph-based model based on a data graph comprising nodes interconnected by edges, wherein the nodes are associated with values for a set of nodal features, and (b) a set of model features, wherein each explanation run involves: (1) identifying (a) a first local search space for a model-feature explanation component that identifies a subset of the set of model features, (b) a second local search space for a subgraph explanation component that identifies a subgraph of the data graph, and (c) a third local search space for a nodal-feature explanation component that identifies a subset of the set of nodal features; (2) navigating the first, second, and third local search spaces to determine a respective candidate explanation that satisfies an explanation rule, wherein the respective candidate explanation comprises (a) a respective subset of the set of model features, (b) a respective subgraph of the data graph, and (c) a respective subset of the set of nodal features; and (3) determining a respective explanation score for the respective candidate explanation; (ii) based on the respective explanation scores for the respective candidate explanations, determine a given explanation for the prediction comprising a given subset of the set of model features, a given subgraph of the data graph, and a given subset of the set of nodal features; and (iii) transmit, to a consumer system, data defining the given explanation and thereby cause an indication of the given explanation to be presented at a user interface of the consumer system.

In an example, the explanation rule limits a size of an explanation for the prediction.

In an example, navigating the first, second, and third local search spaces to determine the respective candidate explanation that satisfies the explanation rule comprises performing a plurality of navigation episodes, wherein each navigation episode comprises the steps of: (i) selecting a given local search space for the navigation episode from the first, second, and third local search spaces, wherein the given local search space corresponds to a given explanation component from the model-feature explanation component, the subgraph explanation component, and the nodal-feature explanation component; (ii) identifying a node within the given local search space representing a current value of the given explanation component and designating the node as a starting node; (iii) determining a plurality of child nodes for the starting node; (iv) determining a respective reward value for each child node in the determined plurality of child nodes; (v) selecting the child node having a highest respective reward value as a winning node from the plurality of child nodes; (vi) evaluating whether a navigation budget has been reached for the given navigation episode; and (vii) based on the evaluating, either: (1) determining that the navigation budget has not been reached for the navigation episode and then carrying out a next iteration of steps (iii)-(vi) using the winning node as a starting node for the next iteration, or (2) determining that the navigation budget has been reached for the navigation episode and then designating the winning node from the most-recent iteration as an ending node for the navigation episode and updating the current value of the given explanation component to be the value represented by the ending node of the navigation episode.

In an example, the navigation budget is a navigation-episode depth of a given number of levels of a Monte Carlo search tree associated with the local search space.

In an example, selecting the given local search space for the navigation episode comprises selecting the given local search space for the navigation episode based on a determination of which of the first, second, and third local search spaces is expected to provide a higher expected reward.

In an example, determining the plurality of child nodes for the starting node comprises sampling a subset of all possible child nodes for the starting node to determine the plurality of child nodes.

In an example, determining the respective explanation score for the respective candidate explanation comprises determining the respective explanation score based on (i) a first importance score determined for the model-feature explanation component, (ii) a second importance score determined for the subgraph explanation component, and (iii) a third importance score determined for the nodal-feature explanation component.

In an example, (i) the first importance score determined for the model-feature explanation component comprises a first Shapley value for the model-feature explanation component, (ii) the second importance score determined for the subgraph explanation component comprises a second Shapley value for the subgraph explanation component, and (iii) the third importance score determined for the nodal-feature explanation component comprises a third Shapley value for the nodal-feature explanation component.

In yet another aspect, disclosed herein is a non-transitory computer-readable medium comprising program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network environment in which aspects of the disclosed technology may be implemented.

FIG. 2 depicts a flow diagram of an example process for explaining predictions of machine-learning models, according to aspects of the disclosed technology.

FIG. 3A depicts a flow diagram of an example process for performing an explanation run, according to aspects of the disclosed technology.

FIG. 3B depicts a flow diagram of an example process for performing multiple explanation runs and using obtained explanation scores as a basis for determining a final explanation, according to aspects of the disclosed technology.

FIG. 4 depicts a flow diagram of an example process for performing a navigation episode during a given navigation run of an explanation run, according to aspects of the disclosed technology.

FIG. 5A depicts a visual representation of an example local search space for a downstream-feature explanation component, according to aspects of the disclosed technology.

FIG. 5B depicts a visual representation of an example local search space for a subgraph explanation component, according to aspects of the disclosed technology.

FIG. 5C depicts a visual representation of an example local search space for a nodal-feature explanation component, according to aspects of the disclosed technology.

FIG. 6 depicts a visual representation of an example navigation episode, according to aspects of the disclosed technology.

FIG. 7 depicts a visual representation of an example of selecting explanation components' local search spaces for navigation episodes, according to aspects of the disclosed technology.

FIG. 8 depicts an example snapshot of a graphical user interface (GUI) that may be presented to a user, according to aspects of the disclosed technology.

FIG. 9 is a simplified block diagram that illustrates some structural components of an example computing platform.

FIG. 10 is a simplified block diagram that illustrates some structural components of an example consumer system.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, organizations in many different industries have begun to operate computing platforms that are configured to ingest, process, analyze, generate, store, and/or output data that is relevant to the businesses of those organizations, which are often referred to as “data platforms.” For example, a financial institution may operate a data platform that is configured to ingest, process, analyze, generate, store, and/or output data related to the financial institution's customers and their financial accounts, such as financial transactions data (among other types of data that may be relevant to the financial institution's business). As another example, an organization interested in monitoring the state and/or operation of physical objects such as industrial machines, transport vehicles, and/or other Internet-of-Things (IoT) devices may operate a data platform that is configured to ingest, process, analyze, generate, store, and/or output data related to those physical objects of interest. As another example, a provider of a Software-as-a-Service (SaaS) application (e.g., a social media application) may operate a data platform that is configured to ingest, process, analyze, generate, store, and/or output data that is created in connection with that SaaS application. Many other examples are possible as well.

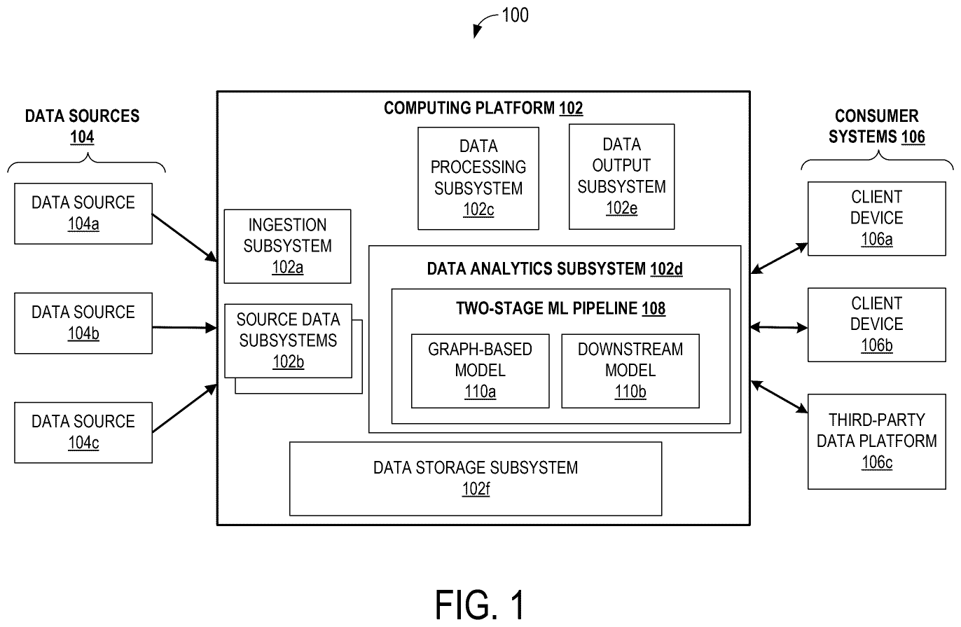

To illustrate with an example, FIG. 1 depicts a network environment 100 that includes at its core an example computing platform 102 that serves as a data platform for an organization, which may comprise a collection of functional subsystems that are each configured to perform certain functions in order to facilitate tasks such as data ingestion, data generation, data processing, data analytics, data storage, and/or data output. These functional subsystems may take various forms.

For instance, as shown in FIG. 1, the example computing platform 102 may comprise an ingestion subsystem 102a that is generally configured to ingest source data from a particular set of data sources 104, such as the three representative data sources 104a, 104b, and 104c shown in FIG. 1, over respective communication paths. These data sources 104 may take any of various forms, which may depend at least in part on the type of organization operating the example computing platform 102. For example, if the example computing platform 102 comprises a data platform operated by a financial institution, the data sources 104 may comprise computing devices and/or systems that generate and output data related to the financial institution's customers and their financial accounts, such as financial transactions data (e.g., purchase and/or sales data, payments data, etc.), customer identification data (e.g., name, address, social security number, etc.), customer interaction data (e.g., web-based interactions with the financial institution such as logins, as well as call logs, chat logs, and/or complaints), and/or credit history data, among various other possibilities. In this respect, the data sources that generate and output such data may take the form of payment processors, merchant service provider systems such as payment gateways, point-of-sale (POS) terminals, automated teller machines (ATMs), computing systems at brick-and-mortar branches of the financial institution, and/or client devices of customers (e.g., personal computers, mobile phones, tablets, etc.), among various other possibilities. The data sources 104 may take various other forms as well.

Further, as shown in FIG. 1, the example computing platform 102 may comprise one or more source data subsystems 102b that are configured to internally generate and output source data that is consumed by the example computing platform 102. These source data subsystems 102b may take any of various forms, which may depend at least in part on the type of organization operating the example computing platform 102. For example, if the example computing platform 102 comprises a data platform operated by a financial institution, the one or more source data subsystems 102b may comprise functional subsystems that internally generate and output certain types of data related to customer accounts (e.g., account balance data, payment schedule data, etc.). The one or more source data subsystems 102b may take various other forms as well.

Further yet, as shown in FIG. 1, the example computing platform 102 may comprise a data processing subsystem 102c that is configured to carry out certain types of processing operations on the source data. These processing operations could take any of various forms, including but not limited to data preparation, transformation, and/or integration operations such as validation, cleansing, deduplication, filtering, aggregation, summarization, enrichment, restructuring, reformatting, translation, mapping, etc.

Still further, as shown in FIG. 1, the example computing platform 102 may comprise a data analytics subsystem 102d that is configured to carry out certain types of data analytics operations based on the processed data in order to derive insights, which may depend at least in part on the type of organization operating the example computing platform 102. For example, if the example computing platform 102 comprises a data platform operated by a financial institution, the data analytics subsystem 102d may be configured to carry out data analytics operations in order to derive certain types of insights that are relevant to the financial institution's business, examples of which could include predictions of fraud, money laundering, or other suspicious activity on a customer's account, and/or predictions of whether to extend credit to an existing or prospective customer, among other possibilities. The data analytics subsystem 102d may be configured to carry out any of numerous other types of data analytics operations as well.

Moreover, the data analytics operations carried out by the data analytics subsystem 102d may be embodied in any of various forms. As one possibility, a data analytics operation may be embodied in the form of a user-defined rule (or set of rules) that is applied to a particular subset of the processed data in order to derive insights from that processed data. As another possibility, a data analytics operation may be embodied in the form of a data science model that is applied to a particular subset of the processed data in order to derive insights from that processed data. In practice, such a data science model may comprise a machine-learning model that has been created by applying one or more machine-learning techniques to a set of training data, but data science models for performing data analytics operations could take other forms and be created in other manners as well. The data analytics operations carried out by the data analytics subsystem 102d may be embodied in other forms as well.

Referring again to FIG. 1, the example computing platform 102 may also comprise a data output subsystem 102e that is configured to output data (e.g., processed data and/or derived insights) to certain consumer systems 106 over respective communication paths. These consumer systems 106 may take any of various forms.

For instance, as one possibility, the data output subsystem 102e may be configured to output certain data to client devices that are running software applications for accessing and interacting with the example computing platform 102, such as the two representative client devices 106a and 106b shown in FIG. 1, each of which may take the form of a desktop computer, a laptop, a netbook, a tablet, a smartphone, or a personal digital assistant (PDA), among other possibilities. These client devices may be associated with any of various different types of users, examples of which may include individuals that work for or with the organization (e.g., employees, contractors, etc.) and/or individuals seeking to obtain goods and/or services from the organization. As another possibility, the data output subsystem 102e may be configured to output certain data to other third-party platforms, such as the representative third-party platform 106c shown in FIG. 1.

In order to facilitate this functionality for outputting data to the consumer systems 106, the data output subsystem 102e may comprise one or more Application Programming Interface (APIs) that can be used to interact with and output certain data to the consumer systems 106 over a data network, and perhaps also an application service subsystem that is configured to drive the software applications running on the client devices, among other possibilities.

The data output subsystem 102e may be configured to output data to other types of consumer systems 106 as well.

Referring once more to FIG. 1, the example computing platform 102 may also comprise a data storage subsystem 102f that is configured to store all of the different data within the example computing platform 102, including but not limited to the source data, the processed data, and the derived insights. In practice, this data storage subsystem 102f may comprise several different data stores that are configured to store different categories of data. For instance, although not shown in FIG. 1, this data storage subsystem 102f may comprise one set of data stores for storing source data and another set of data stores for storing processed data and derived insights. However, the data storage subsystem 102f may be structured in various other manners as well. Further, the data stores within the data storage subsystem 102f could take any of various forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities.

The example computing platform 102 may comprise various other functional subsystems and take various other forms as well.

In practice, the example computing platform 102 may generally comprise some set of physical computing resources (e.g., processors, data storage, etc.) that are utilized to implement the functional subsystems discussed herein. This set of physical computing resources take any of various forms. As one possibility, the computing platform 102 may comprise computing infrastructure of a public, private, and/or hybrid cloud (e.g., computing and/or storage clusters). In this respect, the organization that operates the example computing platform 102 may either supply its own cloud infrastructure or may obtain the cloud infrastructure from a third-party provider of “on demand” cloud computing resources, such as Amazon Web Services (AWS), Amazon Lambda, Google Cloud Platform (GCP), Microsoft Azure, or the like. As another possibility, the example computing platform 102 may comprise one or more servers that are owned and operated by the organization that operates the example computing platform 102. Other implementations of the example computing platform 102 are possible as well.

Further, in practice, the functional subsystems of the example computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

As noted above, the example computing platform 102 may be configured to interact with the data sources 104 and consumer systems 106 over respective communication paths. Each of these communication paths may generally comprise one or more data networks and/or data links, which may take any of various forms. For instance, each respective communication path with the example computing platform 102 may include any one or more of point-to-point data links, Personal Area Networks (PANs), Local Area Networks (LANs), Wide Area Networks (WANs) such as the Internet or cellular networks, and/or cloud networks, among other possibilities. Further, the data networks and/or links that make up each respective communication path may be wireless, wired, or some combination thereof, and may carry data according to any of various different communication protocols. Although not shown, the respective communication paths may also include one or more intermediate systems, examples of which may include a data aggregation system and host server, among other possibilities. Many other configurations are also possible.

It should be understood that the network environment 100 is one example of a network environment in which a data platform may be operated, and that numerous other examples of network environments, data platforms, data sources, and consumer systems are possible as well.

Returning to data analytics subsystem 102d of FIG. 1, in some examples, data analytics subsystem 102d may train and/or execute various different types of data science models (e.g., in order to obtain insights for the organization associated with the computing platform 102).

One example type of data-science model that may be trained and/or executed by data analytics subsystem 102d is a graph-based model. In data science, certain datasets can be encoded in the form of a graph (which may also be referred to herein as a “data graph”). A data graph is a representation of data that includes a collection of nodes (also known as vertices) and edges (also known as links). In general, nodes may represent any of various kinds of data entities, and edges may represent any of various kinds of relationships, connections, and/or interactions between these entities. Additionally, a data graph may also include types and/or attributes for the nodes, the edges, or both. Examples of datasets that may be encoded in graph form might include (i) financial data, such as customer-merchant transactions data that could be modeled as a graph with each node representing a customer or a merchant and each edge representing a transaction between one of the customers and one of the merchants, (ii) biological networks, such as a protein-protein interaction network that could be modeled as a graph with each node representing a protein and each edge representing an interaction between two proteins, (iii) transportation networks, such as a subway system that could be modeled as a graph with each node representing a subway station and each edge representing a railway connecting two stations, or (iv) social network data, which could be modeled as a graph with each node representing an individual person and each edge representing a relationships between two people.

In an example, a graph-based model may be configured to receive an input data graph and produce embeddings based on the input graph. In another example, a graph-based model may be configured to receive an input dataset, construct a data graph based on that input dataset, and produce embeddings for the constructed graph. The inputs and outputs of a graph-based model could take other forms as well.

The embeddings produced by a graph-based model may take any of various forms. In general, the produced embeddings may be some lower-dimensional representation of the structure of the data graph. Further, the graph-based model may produce embeddings for the input graph and/or the constructed graph in any suitable manner. For instance, the graph-based model may be configured to generate embedding vectors for some or all nodes within the graph, which are low-dimensional vectors (relative to the dimension of the graph space) that each encodes information about a respective node such as the respective node's position in the graph and/or the structure of its local neighborhood of nodes in the graph. The graph-based model may be configured to use any of various techniques to generate such embedding vectors, examples of which may include (i) shallow embedding techniques, such as a random walk algorithm (e.g., node2vec or DeepWalk) or a matrix factorization algorithm (e.g., Laplacian cigenmaps, Graph Factorization, GraRep, or HOPE), which typically do not use the attributes of the nodes within the graph and/or (ii) deep embedding techniques, such as the GraphSAGE algorithm, column networks approaches, or graph convolutional networks (GCN) approaches, which typically do use the attributes of the nodes within the graph.

In practice, the graph-based model may comprise a model object that was trained by applying a machine-learning process to a training dataset, although it should be understood that a graph-based model could take various other forms as well.

As one representative example of a graph-based model that is configured to receive or construct a graph and produce embeddings for the graph, the graph-based model may be a Graph Neural Network (GNN) model. GNNs are commonly used in industry for a variety of applications, which may depend at least in part on the type of organization operating the computing platform 102. For instance, GNNs are commonly used for applications such as fraud detection, product recommendations, social networks analysis, transportation network analysis, or drug discovery, among other possibilities. Other examples of graph-based models are possible as well.

Another example type of data-science model that may be trained and/or executed by data analytics subsystem 102d is a data science model that is configured to (i) receive a combination of an embedding (which comprises a set of embedding values) and other features as inputs and then (ii) output a prediction. Such a data science model may be referred to herein as a “downstream model.” In general, the embedding may be an embedding generated by the graph-based model discussed above (which may also be referred to herein as an “upstream graph-based model”) for a graph entity (e.g., a node or edge), and the other features may be features relating to the graph entity that were not produced by the graph-based model. The other features may take various forms. As one possibility, the other features may be original node and/or edge features of the graph from which the embedding was determined by the upstream graph-based model. In an example, the original node and/or edge features may be tabular features (e.g., features relating to data that is organized in a table (e.g., with rows and columns)). As another possibility, the other features may be supplemental features that were not utilized by the upstream graph-based model. Other features are possible as well.

Downstream models such as this may be used in industry for downstream machine-learning tasks, which may depend at least in part on the type of organization operating the example computing platform 102. For instance, if the example computing platform 102 comprises a data platform operated by a financial institution, a financial institution may utilize the downstream model to output any of various types of predictions related to the financial institution's business, which may include a prediction of whether a transaction is a fraudulent transaction, a prediction of whether a customer or merchant is engaged in money laundering activities, or a prediction of whether a customer committed fraud on a credit card application, among various other possibilities. As another example, if the example computing platform 102 comprises a data platform operated by an organization interested in monitoring the state and/or operation of physical objects, the organization may utilize the downstream model to output any of various types of predictions related to the physical objects, which may include a prediction of whether a maintenance and/or repair of the object may be required, among various other possibilities.

In practice, the downstream model may comprise a model object that was trained by applying a machine-learning process to a training dataset, although it should be understood that a downstream model could take various other forms as well.

As one representative example of such a downstream model, the downstream model may be a downstream model that is configured to (i) receive a neural graph embedding generated from an upstream GNN model along with additional other features (e.g., original node or edge features) as input and (ii) render a prediction based on an evaluation of the inputs.

An organization may implement such graph-based models and downstream models in a machine-learning pipeline for the organization. A machine-learning pipeline that includes both (i) a graph-based model and (ii) a downstream model utilizing both an embedding (e.g., a neural graph embedding) and other features as inputs may be referred to herein as a “two-stage machine-learning pipeline.” certain aspects of the inputs to the two-stage machine-learning pipeline (e.g., certain aspects of the input data graph and/or certain of the downstream features) For instance, with reference to FIG. 1, in an example, data analytics subsystem 102d comprises a two-stage machine-learning pipeline 108 that includes both (i) a graph-based model 110a and (ii) a downstream model 110b that utilizes both an embedding (e.g., a neural graph embedding) and other features as inputs. Further, although the graph-based model and the downstream model are described above as being separate machine-learning models, in other embodiments, a two-stage machine-learning pipeline may comprise a single two-stage machine-learning model configured to perform the functions discussed above. For instance, the single two-stage machine-learning model may comprise a model having (i) a first graph-based stage and (ii) a second downstream stage. In general, a two-stage machine learning pipeline may be one or more models that receives as input an input data graph and downstream features. As discussed above, these inputs of (i) an input data graph and (ii) downstream features may be received as input at different stages of the two-stage machine learning pipeline.

While such two-stage machine-learning pipelines may be utilized in industry to obtain predictions, it is difficult to interpret predictions of a downstream model (or downstream stage) of such a two-stage machine-learning pipeline that is configured to utilize (i) an input data graph and (ii) downstream features at different stages of the two-stage machine learning pipeline. In this regard, the downstream model of the two-stage machine-learning pipeline may utilize both an embedding (generated by an upstream graph-based model) and other features as inputs. Notably, in the downstream model or downstream stage, the embedding and the other features may be interrelated (e.g., correlated) and may interact with one another in various ways in the downstream model or stage. For instance, to obtain graph embeddings, a GNN may be applied to the graph with node (or edge) features that might be identical or highly correlated to the other input features (e.g., downstream features). However, it is difficult to provide explanations that take into account the interrelationships and/or interactions between an embedding and the other downstream features and properly measure the importance of the interrelated embedding and the other downstream features.

Various interpretability technologies exist for interpreting predictions of data science models so as to determine an explanation for the prediction (e.g., by producing respective values for the model inputs that indicate the respective contribution or impact of the model inputs), but these existing interpretability techniques fail to provide an explanation for predictions of a two-stage machine learning pipeline that is configured to utilize (i) an input data graph and (ii) downstream features at different stages of the two-stage machine learning pipeline. For instance, existing interpretability techniques fail to provide an explanation for predictions of downstream models that takes into account the interrelationships and/or interactions between an embedding and the other downstream features and properly measures the importance of the interrelated embedding and the other downstream features. In this regard, some existing interpretability technologies perform well on explaining predictions based on geometric inputs (e.g., data graphs) but perform less well on non-geometric input features. For instance, GNNs are efficient in encoding the underlying geometric structure between data points and interpretability technologies exist for predictions that may be made from GNNs; however, GNNs and existing interpretability technologies for predictions that may be made from GNNs typically have suboptimal performance when it comes to non-geometric input features. Further, other existing interpretability technologies perform well on explaining predictions based on non-geometric input features but perform less well on explaining predictions based on geometric inputs (e.g., data graphs). For instance, examples include SHAP (SHapley Additive explanations) and partial dependence plots (PDP) which are not applicable to graph (geometric) data.

However, existing interpretability technologies fail to perform well on predictions based on both data geometric inputs (e.g., data graphs) and non-geometric inputs. More particularly, existing interpretability technologies fail to provide an explanation that takes into account the interrelationship and/or interactions between the embedding and other downstream features. Further, existing interpretability technologies fail to provide an explanation that identifies which downstream features, nodal features and/or neighboring nodes were influential to the prediction. Still further, at best, when applying existing interpretability techniques to a downstream model utilizing both an embedding (generated by an upstream graph-based model) and other features as inputs, the existing interpretability techniques may identify a combination of feature values and embedding values that may contribute most to the output (e.g., prediction) of the downstream model. However, an embedding is a complex vector, and even if one were to identify embedding values as contributing to the prediction, the identified embedding values would have no or limited practical meaning to a user. For instance, the identified embedding values would not inform a user about aspects of the input data graph that contributed to the prediction (e.g., which nodal features and/or neighboring nodes were influential to the prediction). Notably, embeddings are an intermediary component(s) of the machine-learning pipeline with no clear tangible meaning and are hidden from a model-output standpoint. Moreover, treating embeddings as extra synthetic features, along with downstream features and then applying existing interpretability technologies, the existing techniques are inevitably ignoring the interrelationship between the embeddings and the other input features. This is because the existing techniques perturb or change either the embeddings or downstream features, but the two are related naturally through the graph node (or edge) features structure.

To address these and other limitations, disclosed herein is software technology for interpreting (or “explaining”) the predictions of a two-stage machine-learning pipeline that includes both (i) a graph-based model and (ii) a downstream model that renders predictions based on both an embedding (e.g., a neural graph embedding) and other features. The software technology disclosed herein may be implemented by a computing platform operated by any organization that is interested in interpreting the predictions of such two-stage machine-learning pipelines including, for instance, financial institutions, organizations interested in monitoring the state and/or operation of physical objects, or providers of SaaS applications, among other possibilities.

At a high-level, the disclosed software technology may function to: (i) perform a plurality of explanation runs for explaining a prediction rendered by a machine learning model that is configured to receive, as input, (a) an embedding produced by a graph-based model based on a data graph comprising nodes interconnected by edges, wherein the nodes are associated with values for a set of nodal features, and (b) a set of model features, wherein each explanation run involves: (1) identifying (a) a first local search space for a model-feature explanation component that identifies a subset of the set of model features, (b) a second local search space for a subgraph explanation component that identifies a subgraph of the data graph, and (c) a third local search space for a nodal-feature explanation component that identifies a subset of the set of nodal features; (2) navigating the first, second, and third local search spaces to determine a respective candidate explanation that satisfies an explanation rule, wherein the respective candidate explanation comprises (a) a respective subset of the set of model features, (b) a respective subgraph of the data graph, and (c) a respective subset of the set of nodal features; and (3) determining a respective explanation score for the respective candidate explanation; (ii) based on the respective explanation scores for the respective candidate explanations, determine a given explanation for the prediction comprising a given subset of the set of model features, a given subgraph of the data graph, and a given subset of the set of nodal features; and (iii) transmit, to a consumer system, data defining the given explanation and thereby cause an indication of the given explanation to be presented at a user interface of the consumer system.

Beneficially, the disclosed software technology considers the interrelationships and/or interactions between the embedding and other features utilized by a downstream model, and thus the disclosed software technology produces explanations that more properly (as compared to existing interpretability technologies) account for the importance of both the components of the data graph and the other features. Within examples, the disclosed software technology (unlike other interpretability techniques) may beneficially return components of the input graph data and downstream data that have comprehensible meaning to an organization. As mentioned above, embeddings are an intermediary component(s) of the pipeline with no clear tangible meaning and are hidden from a model-output standpoint. However, the disclosed interpretability method may serve to demystify (and, e.g., thus bypass) this intermediary step and find features attributions and a subgraph from the original input with clear readable meaning as the final explanation.

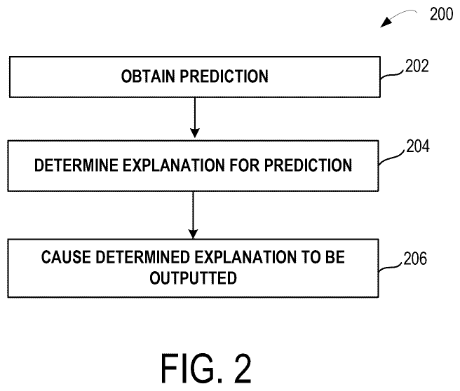

FIG. 2 depicts one example of a process 200 that may be carried out in accordance with the disclosed technology for explaining predictions of two-stage machine-learning pipelines. For purposes of illustration only, example process 200 is described as being carried out by computing platform 102 of FIG. 1, but it should be understood that example process 200 may be carried out by computing platforms that take other forms as well. Further, it should be understood that, in practice, the functions described with reference to FIG. 2 may be encoded in the form of program instructions that are executable by one or more processors of computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 2, the example process 200 may begin at block 202 with computing platform 102 rendering a prediction utilizing a two-stage machine-learning pipeline that includes both (i) an upstream graph-based model and (ii) a downstream model that utilizes as input both an embedding generated from the upstream graph-based model and other features. The prediction may take any of various forms depending on the use case. As one example, the prediction may be a prediction related to whether a given transaction was a fraudulent transaction. As another example, the prediction may be a prediction related to whether a maintenance and/or repair of the object may be required, among various other possibilities. Other predictions are possible as well. Further, the prediction may be any suitable type of prediction. For instance, as one example, the prediction may be a binary “classification” type of prediction. As another example, the prediction may be a numeric prediction such as a likelihood value. Other types of predictions are possible as well.

At block 204 of FIG. 2, computing platform 102 determines an explanation for the prediction in accordance with the disclosed interpretability technology. In general, the disclosed interpretability technology involves determining an explanation for the prediction that identifies certain aspects of the inputs to the two-stage machine-learning pipeline (e.g., certain aspects of the input data graph and/or certain of the downstream features) that are determined to be most influential to the prediction rendered by the two-stage machine-learning pipeline. For instance, continuing the illustrative example where the prediction is a prediction related to whether a given transaction was a fraudulent transaction, the prediction may be that a given transaction is a fraudulent transaction, and the explanation may identify certain aspects of the two-stage machine-learning pipeline's inputs that were determined to be most influential to the pipeline's prediction that the given transaction is a fraudulent transaction.

The aspects of the two-stage machine-learning pipeline's inputs that are identified by the explanation as being most influential to the pipeline's prediction may take various forms. At a high-level, an explanation for a pipeline's prediction may have up to three explanation components: (i) a set of one or more downstream features (which may be referred to herein as a “downstream-feature explanation component”), (ii) a subgraph (which may be referred to herein as a “subgraph explanation component”), and (iii) a set of one or more nodal features (which may be referred to herein as a “nodal-feature explanation component”) that are collectively determined to be most influential to the prediction. (It should be understood that the phrase “determined to be most influential” as used herein refers to the combination of explanation components that is determined to be most influential relative to the other combinations of explanation components that are evaluated by the disclosed technology, not relative to all possible combinations of explanation components that could theoretically be evaluated.)

The identified set of one or more downstream features may take various forms. In general, each downstream feature in the set of one or more downstream features may be a respective input feature utilized by the downstream model. The set of one or more downstream features included in an explanation may be features from a universe of downstream features.

Further, the subgraph may take various forms. In general, the subgraph may be a given sub-part of the data graph that is provided as input to the upstream graph-based model. For instance, in an example, the subgraph may be an interconnected subset of nodes and/or edges from the input graph.

Still further, the identified set of one or more nodal features may take various forms. In general, each nodal feature in the set of one or more nodal features may be a respective feature of the nodes of the data graph that is provided as input to the upstream graph-based model. The set of one or more nodal features included in an explanation may be features from a universe of nodal features.

The identified set of one or more downstream features, subgraph, and set of one or more nodal features included in the explanation for the prediction will depend on the two-stage machine-learning pipeline from which the prediction is obtained. As a representative example, and continuing the example where the prediction is a prediction related to whether a given transaction was a fraudulent transaction, the downstream model may utilize a universe of downstream features such as transaction amount, IP address for transaction, fraud rate for the merchant associated with the transaction (e.g., fraud rate for past 30 days, 60 days, and/or 90 days), average transaction amount for a customer, average transaction amount per good and/or service category for a customer, and/or average total monthly transaction amount for a customer, among other possibilities. The downstream-feature explanation component may be a set of one or more downstream features (from the universe of downstream features) that are identified as being influential to the prediction. Further, the input graph may take the form of a graph where clients and merchants are nodes and transactions are edges (e.g., a graph comprising a seed node associated with the prediction and nodes within a threshold number of hops from the seed node), and the subgraph explanation component may be a sub-part of that input graph (e.g., a set of nodes interconnected by edges) that is identified as being influential to the prediction. Still further, there may be a universe of nodal features associated with the nodes of the input graph, including, for instance, features related to client information (e.g., billing address, credit score, among other possibilities) and merchant information (e.g., merchant address, goods and/or services associated with merchant, among other possibilities). The nodal-feature explanation component may be a set of one or more nodal features (from the universe of nodal features) that are identified as being influential to the prediction.

The disclosed interpretability technology may also utilize an explanation rule (comprising one or more explanation requirements) when carrying out the process of determining an explanation for a prediction. For instance, as one possibility, computing platform 102 may define an explanation rule that limits the size of an explanation for a prediction. This explanation rule (comprising one or more explanation requirements) that limits the size of the explanation may take various forms. As one possibility, the explanation rule comprises, for each explanation component, a requirement that limits the total number of dimensions of the explanation component. In such a case, the dimensions of an explanation component may depend on the type of the explanation component. For instance, in an example, the limit on the total number of dimensions of the downstream-feature explanation component may define the maximum number of downstream features that can be included in the downstream-feature explanation component, the limit on the total number of dimensions of the subgraph explanation component may define the maximum number of nodes that can be included in the subgraph of the subgraph explanation component, and the limit on the total number of dimensions of the nodal-feature explanation component may define the maximum number of nodal features that can be included in the nodal-feature explanation component. In other examples, rather than defining a maximum number of dimensions that can be included in the explanation component, a requirement of an explanation rule may take the form of a requirement of a given number of dimensions to be included in the explanation component. Other examples are possible as well.

As another possibility, the explanation rule comprises a requirement that limits the collective number of dimensions across the explanation components. For instance, the explanation rule may define a limit on the sum of (i) the number of downstream features to be included in the downstream-feature explanation component, (ii) the number of nodes to be included in the subgraph of the subgraph explanation component, and (iii) the number of nodal features to be included in the nodal-feature explanation component. Other example explanation requirements are possible as well.

Other explanation rules are possible as well. In an example, other rules and/or requirements may be determined based on business or strategy needs. For instance, in some circumstances, the subgraph (or geometric) aspect of the data may be more important based on business or strategy needs than its non-geometric or tabular structure of the data and, thus, a rule and/or requirement may be defined such that importance is accordingly reflected in the returned explanation. Further, in some examples, one may use the sparsity of the matrices to define new rules and/or requirements as well.

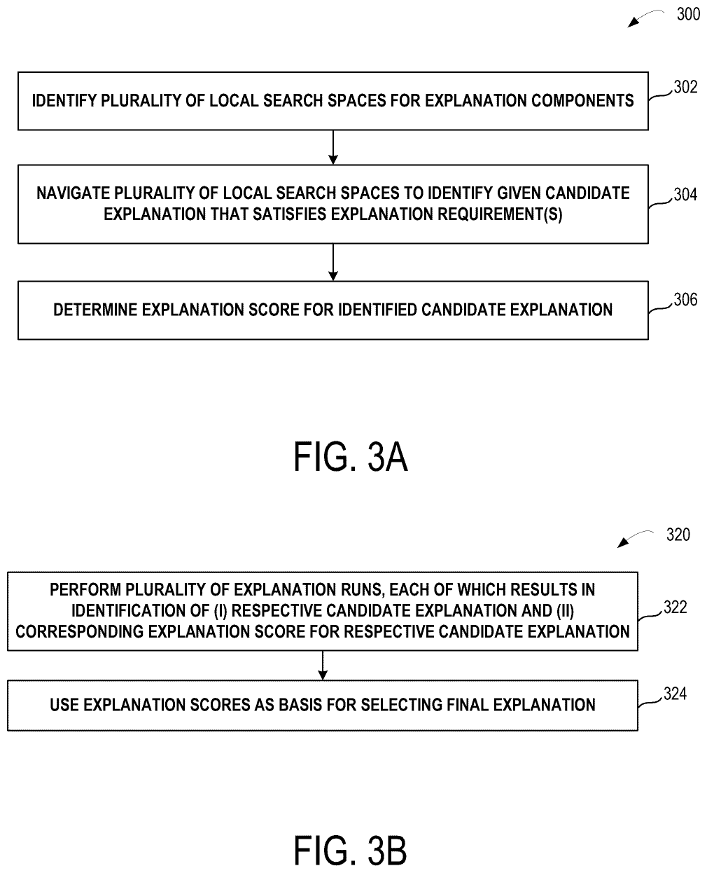

In operation, the disclosed interpretability technology (i) determines (a) a plurality of candidate explanations that could potentially serve as an explanation for the prediction rendered by the two-stage machine-learning pipeline, each of which comprises a respective combination of (1) a set of one or more downstream features, (2) a subgraph, and (3) a set of one or more nodal features, and (b) corresponding explanation scores for the candidate explanations that each quantifies the impact of its respective combination of 1) a set of one or more downstream features, (2) a subgraph, and (3) a set of one or more nodal features to the prediction and then (ii) selects the candidate explanation having the highest explanation score as the final explanation for the prediction. The process for determining a given candidate explanation and its explanation score may be referred to as an “explanation run,” and the disclosed interpretability technology may iterate through multiple different explanation runs, each of which results in the determination of a respective candidate explanation along with a corresponding explanation score. The functionality that is carried out during each explanation run may take various forms, and one embodiment of such functionality will be described in further detail below with reference to FIG. 3.

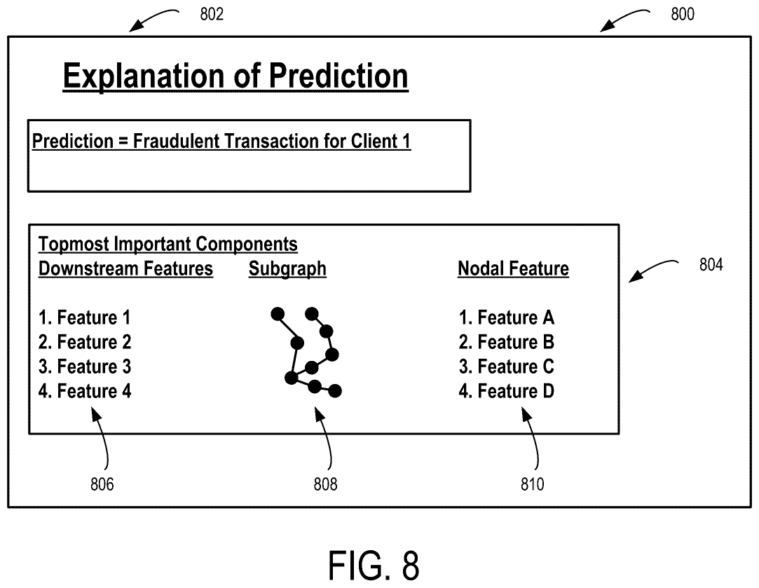

At block 206 of FIG. 2, computing platform 102 causes the final explanation to be outputted to a consumer system 106, such as client device 106a, client device 106b, or third-party data platform 106c. For instance, computing platform 102 may transmit, to consumer system 106, data defining the explanation and thereby cause an indication of the explanation to be presented at a user interface of the consumer system. The output may take any of various forms depending on the use case. In an example, the output may take the form of a presentation of the (i) set of one or more downstream features, (ii) subgraph, and (iii) set of one or more nodal features of the determined explanation that are collectively determined to be most influential to the prediction. An example output will be described in further detail below with reference to FIG. 8.

As mentioned above, existing interpretability techniques fail to provide an explanation for predictions of a two-stage machine learning pipeline that is configured to utilize (i) an input data graph and (ii) downstream features at different stages of the two-stage machine learning pipeline. Beneficially, the final explanation determined in accordance with the disclosed interpretability technology provides an explanation that (i) takes into account the interrelationship and/or interactions between the embedding and other downstream features and (ii) identifies which downstream feature(s), neighboring node(s), and nodal feature(s) were influential to the prediction.

The determined, final explanations may be utilized by organizations in any suitable manner, which may take any of various forms. As one possibility, the determined explanations may be utilized to determine insights and/or trends related to data (e.g., financial data). For instance, in an example, the determined explanations may be utilized to explain common factors that influence behavior of a customer or a set of customers. Other examples include utilizing the determined explanations to understand fraud activities (e.g., fraud rings/clusters) and/or anti-money laundering (AML) use cases. This includes both transactions fraud or application fraud (e.g., applying for a financial product such as a credit card or a personal loan). Other examples exist where the organization uses a graph to discover trends in consumer spending to optimize and/or market new products. Furthermore, such interpretability pipelines can be used to further understand customer base population segmentation, which may be helpful for a variety of business needs.

As another possibility, the determined explanations may be utilized in further downstream tasks for the organization. Downstream tasks may take any of various forms depending on the use case. For instance, as one example, in a use case where an organization is determining whether to take a given action (e.g., whether to extend credit to an individual where a graph embedding is leveraged for credit decisioning), the organization may generate one or more reason codes related to the determination based on the determined explanation (e.g., generate one or more Adverse Action Reason Codes (AARC) based on a determination to not extend credit). Other examples of utilizing the determined explanations are possible as well.

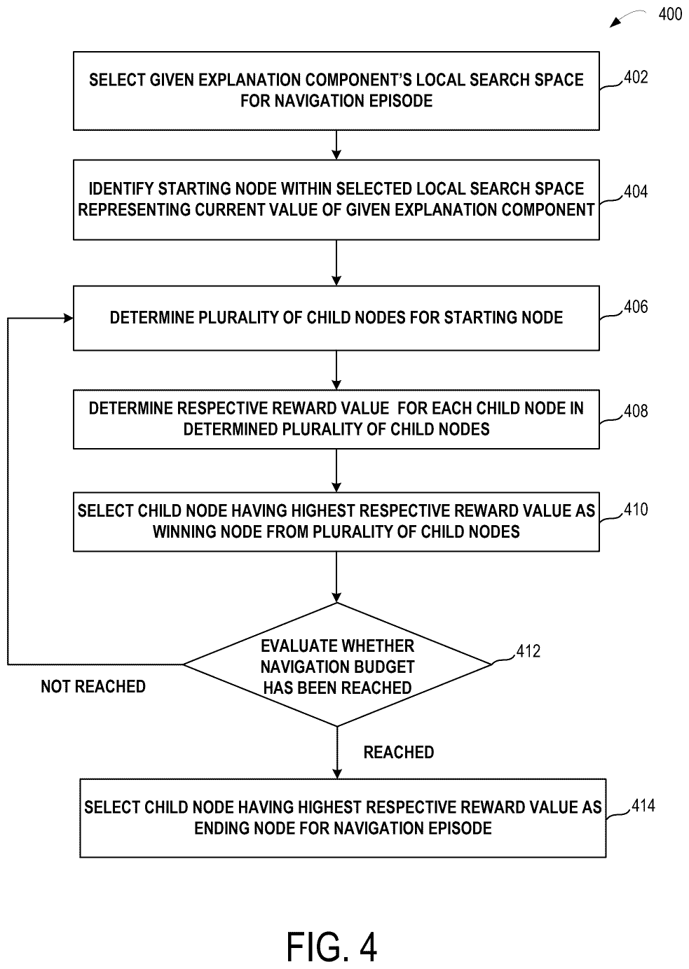

The functionality of determining an explanation for a prediction discussed with respect to block 204 will now be discussed in greater detail below with reference to FIGS. 3A-4. Turning first to FIG. 3A, a flow diagram of an example process 300 that may be carried out by computing platform 102 in order to perform an explanation run is depicted. For purposes of illustration only, example process 300 is described as being carried out by computing platform 102 of FIG. 1, but it should be understood that example process 300 may be carried out by computing platforms that take other forms as well. Further, it should be understood that, in practice, the functions described with reference to FIG. 3A may be encoded in the form of program instructions that are executable by one or more processors of computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 3A, the example process 300 may begin at block 302 with computing platform 102 identifying a plurality of local search spaces for the three explanation components (i.e., a downstream-feature explanation component, a subgraph explanation component, and a nodal-feature explanation component). A local search space for a given explanation component may generally comprise the universe of options that may be considered (e.g., evaluated) for the given explanation component. For example, if the given explanation component is a set of one or more downstream features, then the local search space may comprise the universe of possible downstream-feature combinations that may be considered for the downstream-feature component of the explanation. Further, if the given explanation component is a subgraph, then the local search space may comprise the universe of possible subgraph options that may be considered for the subgraph component of the explanation. Still further, if the given explanation component is a set of one or more nodal features, then the local search space may comprise the universe of possible nodal-feature combinations that may be considered for the nodal-feature component of the explanation.

In practice, a local search space for a given explanation component may be visualized as a tree, where higher levels of the tree correspond to options for the given explanation component that have a larger number of dimensions and lower levels of the tree correspond to options for the given explanation component that have a smaller number of dimensions. For example, if the given explanation component is a downstream-feature component, then the first level of the local search space may comprise a root node representing the entire set of downstream features for the downstream model, which will be the option for the downstream-feature component that has the largest number of dimensions. Thereafter, each subsequent level of the tree may comprise nodes representing combinations of downstream features having one less dimension than the prior level (e.g., the nodes on the second level of the tree each have one less dimension than the root node on the first level, the nodes on the third level of the tree each have one less dimension than the nodes on the second level, and so on).

As another example, if the given explanation component is a subgraph, then the first level of the local search space may comprise a root node representing an entire knowledge graph utilized by the downstream model, which will be the option for the subgraph that has the largest number of dimensions. As mentioned above, the subgraph may be a given sub-part of the data graph that is provided as input to the upstream graph-based model to generate embeddings. The knowledge graph may be the entire data graph or part of the data graph used by the upstream graph-based model. For instance, in an example, the prediction may be associated with a given node of a graph, and the knowledge graph may be the portion of the graph that is within a given number of hops of the given node. Any suitable number of hops is possible, such as between 2 to 10 hops, among other possibilities. After the root node, each subsequent level of the tree may comprise subgraphs having one less dimension than the prior level (e.g., subgraphs on the second level of the tree each have one less dimension than the root node on the first level, the subgraphs on the third level of the tree each have one less dimension than the subgraphs on the second level, and so on).

As yet another example, if the given explanation component is a nodal-feature component, then the first level of the local search space may comprise a root node representing the entire set of nodal features for knowledge graph, which will be the option for the nodal-feature component that has the largest number of dimensions. Thereafter, each subsequent level of the tree may comprise nodes representing combinations of nodal features having one less dimension than the prior level (e.g., the nodes on the second level of the tree each have one less dimension than the root node on the first level, the nodes on the third level of the tree each have one less dimension than the nodes on the second level, and so on).

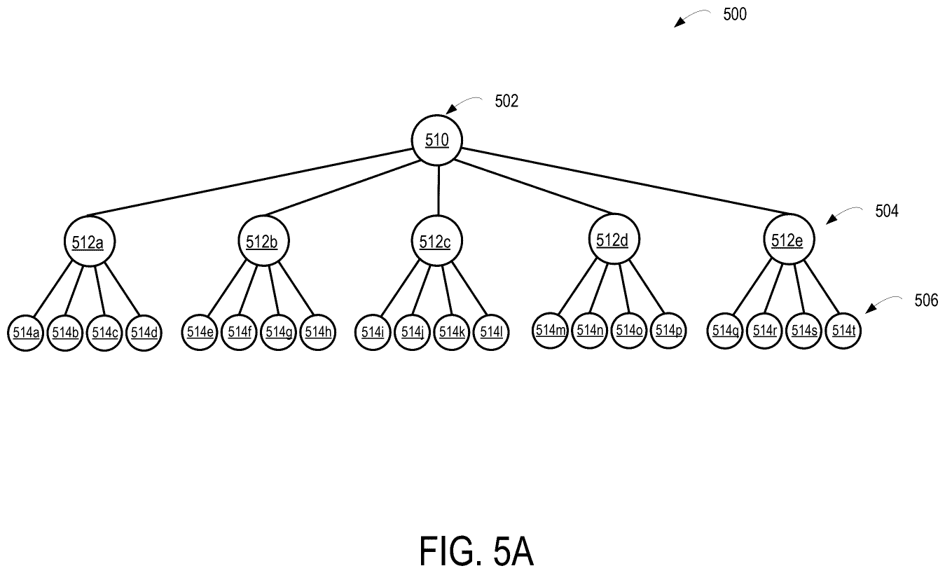

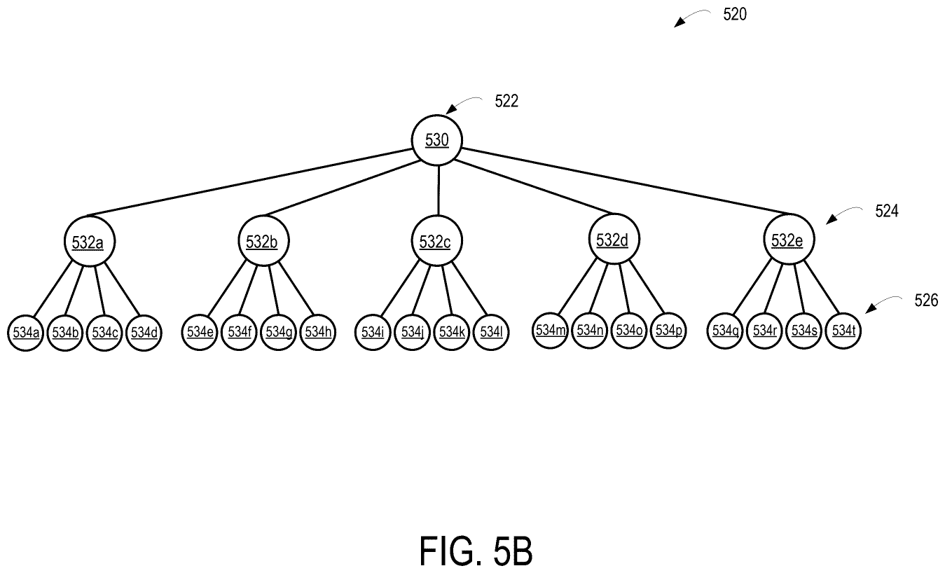

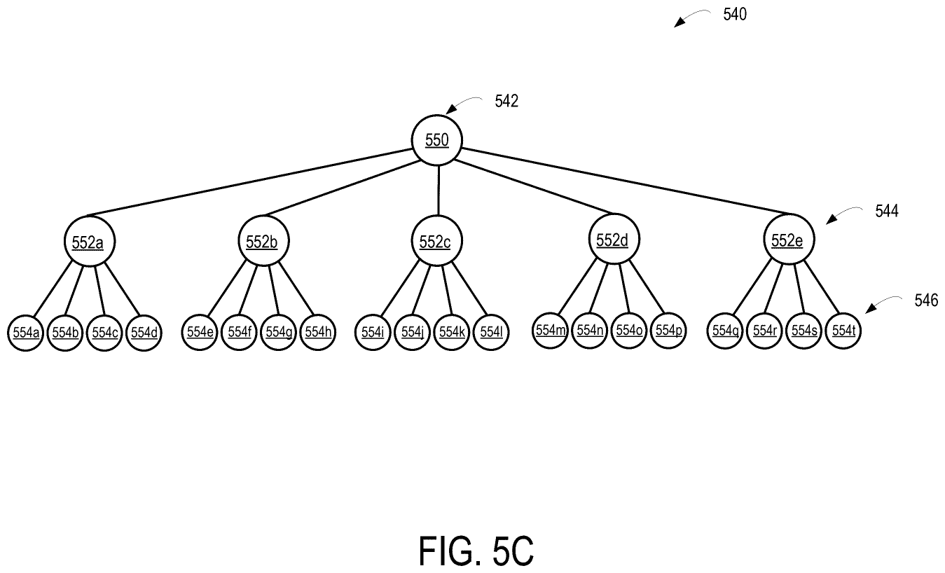

Simplified, illustrative examples of local search spaces are shown in FIGS. 5A-C. Turning first to FIG. 5A, a simplified example downstream-feature local search space 500 is illustrated. Downstream-feature local search space 500 includes a first level 502, a second level 504, and a third level 506. First level 502 includes root node 510, second level includes child nodes 512a-e, and third level includes child nodes 514a-t. As mentioned above, each subsequent level of a tree may comprise nodes representing combinations of downstream features having one less dimension than the prior level. Thus, child nodes may be nodes that have one fewer feature than its parent node in the preceding level. For instance, in this simplified example, root node 510 may have five features (e.g., features 1, 2, 3, 4, and 5), and thus child nodes 512a-e may each have four features. For instance, child node 512a may include features 2, 3, 4, and 5, child node 512b may include features 1, 3, 4, and 5, child node 512c may include features 1, 2, 4, and 5, child node 512d may include features 1, 2, 3, and 5, and child node 512e may include features 1, 2, 3, and 4. Similarly, child nodes 514a-t in third level may each include three features. Other examples are possible as well. Downstream-feature local search space 500 may be navigated as described below to determine which downstream features may be deemed most important to a prediction.

Turning next to FIG. 5B, a simplified example subgraph local search space 520 is illustrated. Subgraph local search space 520 includes a first level 522, a second level 524, and a third level 526. First level 522 includes a root node 530, second level includes child nodes 532a-c, and third level 526 includes child nodes 534a-t. In this simplified example, root node 530 may correspond to a subgraph having five dimensions (e.g., five nodes), child nodes 532a-e may each correspond to a subgraph having four dimensions, and child nodes 534a-t may correspond to a subgraph having three dimensions. Subgraph local search space 520 may be navigated as described below to determine which subgraph may be deemed most important to a prediction.

Turning next to FIG. 5C, a simplified example nodal-feature local search space 540 is illustrated. Nodal-feature local search space 540 includes a first level 542, a second level 544, and a third level 546. First level 542 includes root node 550, second level includes child nodes 552a-c, and third level includes child nodes 554a-t. In this simplified example, root node 550 may have five features, child nodes 552a-e may each have four features, and child nodes 554a-t may each include three features. Nodal-feature local search space 540 may be navigated as described below to determine which nodal features may be deemed most important to a prediction.

In practice, the size of the downstream-feature search space, subgraph search space, and nodal-feature search space will depend on the two-stage machine-learning pipeline from which the prediction is obtained. For example, a number of nodes in a tree corresponding to a search space may depend on a number of dimensions of the root node. In this regard, a root node having a higher number of dimensions will have a higher number of child nodes (compared to a root node having a lower number of dimensions). For instance, for the example downstream-feature local search space 500, root node 502 may be a node that comprises five downstream features. However, in practice the root node may have fewer downstream features (e.g., four or fewer) or more downstream features (e.g., on the order of tens, hundreds, or thousands, among other possibilities).

Further, in some examples, the depth of the tree corresponding to the search space may depend on the explanation requirement(s) for the explanation. For instance, continuing the example root node 502 comprises five downstream features, the explanation requirements for the explanation may comprise a requirement that the downstream-feature component include three downstream features, which thereby leads to downstream-feature local search space 500 including three levels. However, the number of dimensions of the nodes at the lowest level of downstream-feature local search space 500 may depend on the explanation requirement(s). For instance, as one possibility, in an example where the explanation requirements comprise a requirement of the downstream feature set to have two dimensions rather than three dimensions, the downstream-feature local search space 500 may include one additional level below level 506. As another possibility, in an example where the explanation requirements comprise a requirement that the explanation has a limit on the total number of dimensions of the explanation, it may be possible that the downstream-feature component could have a single dimension. In such an example, the downstream-feature local search space 500 may go down to a single dimension and thus include three additional levels below level 506.

Returning to FIG. 3, at block 304, computing platform 102 navigates the plurality of local search spaces to identify a given candidate explanation that satisfies the explanation rule (i.e., a given combination of (i) a set of one or more downstream features, (ii) a subgraph, and (iii) a set of one or more nodal features that satisfies the explanation rule). Navigating the plurality of local search spaces during an explanation run to identify a given candidate explanation may be referred to herein as a “navigation run.”

The functionality of navigating the plurality of local search spaces to identify a given candidate explanation may take various forms. As one possibility, this navigation functionality begins by designating the root node of each local search space as the current value of each explanation component. The combination of the current values for the three explanation components may be referred to as the “current state” of the navigation run. The navigation functionality then involves a sequence of “navigation episodes” that are intended to iterate through different combinations of values for the explanation components until a combination is reached that satisfies the explanation rule. Each navigation episode operates on one given explanation component's local search space and involves navigating from a higher-level node of the local search space (i.e., a node having a larger number of dimensions) to a lower-level node of a local search space (i.e., a node having a smaller number of dimensions) that is designated as the current value for the given explanation component. For instance, if the first navigation episode operates on the local search space for the downstream-features explanation component, that navigation episode may involve navigating from the root node of the local search space to a given lower-level node of the local search space that represents a given downstream-feature combination, which is then designated as the current value for the downstream-feature explanation component. The functionality that is carried out during each navigation episode is described in further detail below with respect to FIG. 4.

After each navigation episode, the current value of one of the three explanation components is updated. For example, if the first navigation episode operates on the local search space for the downstream-feature component, then the current value for the downstream-feature component is updated to be a given downstream-feature combination having a smaller number of dimensions than the prior candidate value, while the current values for the subgraph component and the nodal-feature component of the explanation remain the same. Further, after each navigation episode, the navigation functionality evaluates whether the updated combination of current values for the explanation components meets the explanation rule. As mentioned above with respect to FIG. 2, the explanation rule may take various forms and, in general, may limit the size of an explanation for a prediction. If the updated combination of current values for the explanation components meets the explanation rule, the navigation functionality then uses the updated combination of current values for the explanation components as the candidate explanation for the navigation run. On the other hand, if the updated combination of current values for the explanation components does not meet the explanation rule, the navigation functionality may then carry out another navigation episode.

This process continues in an iterative fashion until there is a navigation episode in the navigation run that results in the identification of a combination of values for the explanation components that meet the explanation rule. For instance, in a case where the explanation rule comprises a requirement limiting the total number of dimensions of the explanation, this process ends when the total dimensions of the three explanation components falls within the limit on the total number of dimensions of the explanation. As another example, in a case where the explanation rule comprises, for each explanation component, a requirement limiting a total number dimensions of the explanation component, this process ends when, for each explanation component, the dimensions of the explanation component falls within the limit on a total number dimensions of the explanation component. For instance, in an example and with reference to FIGS. 5A-C, the explanation rule may include a requirement that the downstream-feature explanation component be limited to three dimensions, a requirement that the subgraph explanation component be limited to three dimensions, and a requirement that the nodal-feature explanation component be limited to three dimensions. Thus, in this example, the combination of current values for the explanation components may meet the explanation rule when the combination of current values comprises a set of downstream features having three or fewer dimensions (i.e., the set of components of one of the child nodes in level 506), a subgraph having three or fewer dimensions (i.e., the set of components of one of the child nodes in level 526), and a set of nodal features having three or fewer dimensions (i.e., the set of components of one of the child nodes in level 546).

At block 306, computing platform 102 determines an explanation score for the identified candidate explanation. Determining an explanation score for the identified candidate explanation may take various forms. In general, the explanation score quantifies the collective impact of the downstream-feature explanation component, the subgraph explanation component, and the nodal-feature explanation component to the prediction.

The functionality of determining an explanation score may take various forms. In an example, the explanation score for an identified candidate explanation may be based on “importance scores” assigned to the individual explanation components. The importance scores assigned to the individual components may take any of various forms. In general, the importance score may quantify the impact of the explanation component to the prediction. Further, the importance score for a given explanation component may be based on the current value of the given explanation component as well as the current values for the other two explanation components, one example of which is described in more detail below. By having an importance score for a given explanation component being based on the current values of the entire set of explanation components, the importance score for a given explanation component may not just reflect the influence of the features of the explanation component on the prediction in isolation, but the importance score may also reflect interrelatedness between those features of the explanation component and the features of the other explanation components.

As one possible implementation of determining importance scores for explanation components (and thereafter determining an explanation score based on the determined importance scores), the importance scores of the explanation components may comprise Shapley values for these explanation components. After the Shapley values for each explanation component in the identified candidate explanation are determined, the explanation score for the identified candidate explanation may in turn be determined based on the three Shapley values for the three explanation components.

As a representative example of determining Shapley values for explanation components (and thereafter determining an explanation score based on the determined Shapley values), the following example is described in which one may consider a representative example where a prediction is associated with a target node v of the graph input to the graph-based model. In this representative example where a prediction is associated with a target node v, the k-hop neighborhood of a target node v may be identified with [symbol] (v), which comprises the knowledge graph [symbol] with nodes {v₁, . . . , vₘ} and the adjacency matrix [symbol] ∈ [symbol] . The node and edge features may be, respectively, given by Xᵥ∈ [symbol] and Xₑ_{ᵤᵥ}∈ [symbol] vectors. For simplicity and without loss of generality, this representative example makes the assumption that node and edge features are of the same dimension, although in other examples the node and edge features may be of different dimensions.

The graph embedding for node v from the l-th layer of the graph-based model may be given by

$${h}_{v}^{l} = {f}_{v}^{e} ( {𝒢}_{v} ) ∈ {ℝ}^{D} ,$$

where D is the hidden dimension of the l-th output layer. The disclosed navigation functionality may be used to determine an explanation for a prediction of a downstream model where the neural graph embedding

$${h}_{v}^{l}$$

is augmented with downstream features denoted by xᵥ∈ [symbol] :

$${x}_{v} = \{ {x}_{1}^{v} , … , {x}_{n}^{v} \} . \qquad ( Eq . 1 )$$

Computing platform 102 may generate an instance-level explanation for the prediction of the seed node v when its embedding

$${h}_{v}^{l}$$

is used at downstream such that:

$${f}^{d} ( {x}_{v} ‖ {h}_{v}^{k} ) = {f}^{d} ( {x}_{v} ‖ {f}_{v}^{e} ( {q}_{v} ) ) . \qquad ( Eq . 2 )$$

For the remainder of the discussion of this representative example, the discussion assumes that the explained node is v, and thus the subscript v is dropped for the sake of brevity.

In this representative example, the Shapley values for the three explanation components may be defined as:

$${φ}^{( {S}^{′} , {𝒢}^{′} , M )} ( {S}^{′} ) := {\sum }_{{S}_{1} ⊆ N ∖ {S}^{′}} \frac{\vert {S}_{1} \vert ! \cdot ( n - {s}^{′} - \vert {S}_{1} \vert ) !}{( n - {s}^{′} + 1 ) !} \cdot [ \text{} {f}^{d} ( {x}_{{S}_{1}} , {x}_{{S}^{′}} , {x}_{N ∖ ( {S}_{1} ⋃ {S}^{′} )}^{*} , {f}^{e} ( {( {𝒢}^{′} )}^{M} ) ) - {f}^{d} ( {x}_{{S}_{1}} , {x}_{N ∖ {S}_{1}}^{*} , {f}^{e} ( {( {𝒢}^{′} )}^{M} ) ) ] , \qquad ( Eq . 3 )$$

$${φ}^{( {S}^{′} , {𝒢}^{′} , M )} ( {𝒢}^{′} ) := {\sum }_{{S}_{2} ⊆ \{ {v}_{k + 1} , … , {v}_{m}} \frac{\vert {S}_{1} \vert ! \cdot ( m - k - \vert {S}_{2} \vert ) !}{( m - k + 1 ) !} \cdot [ \text{} {f}^{d} \text{} ( {x}_{{S}^{′}} , {x}_{N ∖ {S}^{′}}^{*} , {f}^{e} ( {( {𝒢}^{′} ⋃ {S}_{2} )}^{M} ) ) - {f}^{d} ( {x}_{{S}_{1}} , {x}_{N ∖ {S}^{′}}^{*} , {f}^{e} ( {( {S}_{2} )}^{M} ) ) ] , \qquad ( Eq . 4 )$$

$${φ}^{( {S}^{′} , {𝒢}^{′} , M )} ( M ) := {\sum }_{{S}_{3} ⊆ N ∖ M} \frac{\vert {S}_{3} \vert ! \cdot ( n - \vert M \vert - \vert {S}_{3} \vert ) !}{( n - \vert M \vert + 1 ) !} \cdot [ \text{} {f}^{d} ( {x}_{{S}^{′}} , {x}_{N ∖ {S}^{′}}^{*} , {f}^{e} ( {( {𝒢}^{′} )}^{M ⋃ {S}_{3}} ) ) - {f}^{d} ( {x}_{{S}^{′}} , {x}_{N ∖ {S}^{′}}^{*} , {f}^{e} ( {( {𝒢}^{′} )}^{M} ) ) ] , \qquad ( Eq . 5 )$$

where the set of players for each game may be defined as:

$${P}^{{S}^{′}} := \{ {S}^{′} , {\overbrace{{x}_{{s}^{′} + 1} , … , {x}_{n}}}^{features not in {S}^{′}} \} , \qquad ( Eq . 6 )$$

$${P}^{{𝒢}^{′}} := \{ {( {𝒢}^{′} )}^{M} , {\overbrace{{v}_{k + 1} , … , {v}_{m}}}^{nodes not in {𝒢}^{′}} \} , \qquad ( Eq . 7 )$$

$${P}^{M} := \{ {\overbrace{{𝒳}_{1} , … , {𝒳}_{n - \vert M \vert}}}^{features not masked by M} , {\overbrace{( {𝒳}_{n - \vert M \vert + 1} , … , {𝒳}_{n} )}}^{features masked by M} \} . \qquad ( Eq . 8 )$$

In the above equations, (i) S′ denotes a downstream feature mask applied to the downstream features (which thereby defines a current value for the downstream-feature explanation component) used to identify topmost downstream features, (ii) [symbol] denotes a subgraph of the knowledge graph (which defines a current value for the subgraph explanation component) which may be a candidate for the most important subgraph, and (iii) M defines a nodal feature mask applied to the nodal features in the subgraph [symbol] (which thereby defines a current value for the nodal-feature explanation component) that is going to identify the topmost important nodal features in the subgraph [symbol] . Further, for the sake of simplicity in this representative example, it is assumed that the nodal feature mask is uniformly applied to all nodes. However, in other examples, nonuniform nodal feature masks are possible.

At a high level, computing platform 102 may utilize these Eqs. 1-8 to perform a game-theoretic approach for determining the Shapley values in which computing platform 102 may “play” these “games” by iterating over different values of elements (depending on the equation). More particularly, with reference to Eq. 3, computing platform 102 may iterate over subsets S₁ of downstream features not masked by S′ (s′ denotes the size of S′). Thus, computing platform 102 may determine the Shapley value of S′ in a game defined based on (S′, [symbol] , M), whose players are given by P^{S′}, i.e., the mask S′ of the downstream features, along with downstream features not in S′. Further, with reference to Eq. 4, computing platform 102 may iterate over subsets S₂ of nodes which are not in [symbol] ′. Hence, computing platform 102 may determine the Shapley value of [symbol] ′ in a game defined based on (S′, [symbol] , M), whose players are given by P [symbol] ^{′}, i.e., the subgraph [symbol] ′ and the nodes of the computational graph [symbol] that are not in [symbol] ′ denoted by {vₖ₊₁, . . . , vₘ}. Finally, with reference to Eq. 5, computing platform 102 may iterate over subsets S₃ of node features not masked by M (the size of M, which gives the number of features masked by M is denoted by |M|). The players of a game defined with values in Eq. 5 are given by P^{M} which includes the node features masked by M (as a single player) and those not masked by M. Note that, in this representative example, x* denotes a baseline datapoint from downstream feature distribution (often obtained by taking the average over the whole distribution). Moreover, in this representative example computing platform 102 may adopt a zero-padding strategy to compute terms such as f^{e}(( [symbol] ′)^{M}) by setting features of nodes not belonging to [symbol] ′ to zero and applying the mask M to features of nodes belonging to M. Furthermore, as described in further detail below, these games may involve utilizing a Monte Carlo Tree Search (MCTS) and Monte Carlo sampling throughout the course of playing these aforementioned “games.”

As indicated in the above equations, the Shapley value for each given explanation component are not only based on the current value of the given explanation component, but are also based on the current values for the other two explanation components. By having the Shapley value for a given explanation component being based on not only the given explanation component but also the current values of the other two explanation components, the Shapley value for the given explanation component may reflect interrelatedness between the features of the explanation component and the features of the other explanation components.

Having defined the Shapley value for each explanation component in (S′, [symbol] ′, M), the explanation score for the identified explanation may be determined based on the Shapley values for the explanation components. For instance, the explanation score may be defined as:

$${φ}^{( {S}^{′} , {𝒢}^{′} , M )} ( {S}^{′} , {𝒢}^{′} , M ) := {φ}^{( {S}^{′} , {𝒢}^{′} , M )} ( {S}^{′} ) + {λ}^{{𝒢}^{′}} \cdot {φ}^{( {S}^{′} , {𝒢}^{′} , M )} ( {𝒢}^{′} ) + {λ}^{M} \cdot {φ}^{( {S}^{′} , {𝒢}^{′} , M )} ( M ) , \qquad ( Eq . 9 )$$

where [symbol] and λ^{M} are constants that control the relative importance of the subgraph [symbol] ′ and the node feature mask M as components of the explanation with respect to each other as well as relative to the downstream feature mask S′.

In practice, these constants λ [symbol] ^{′} and λ^{M} may be determined in various manners including, for instance, based on expert knowledge. Further, in some examples, these hyperparameters may be set and/or adjusted depending on different use cases and/or organization preferences.

The explanation score [symbol] (S′, [symbol] ′, M) quantifies the collective impact of the downstream-feature explanation component, the subgraph explanation component, and the nodal-feature explanation component to the prediction.

It should be understood that the foregoing is a representative example for determining importance scores for explanation components (and thereafter determining an explanation score based on the determined importance scores). Other examples of assigning importance scores to an explanation component and an explanation score to a candidate explanation are possible as well.

The foregoing explanation-run functionality of example process 300 described above with respect to FIG. 3A may be repeated for multiple explanation runs, each of which results in the identification of (i) a respective candidate explanation and (ii) a corresponding explanation score for the respective candidate explanation. The explanation scores may then be used as a basis for selecting the final explanation for the prediction.

As mentioned above, computing platform 102 may perform multiple explanation runs and use the identified explanation scores as a basis for selecting the final explanation for a prediction. A flow diagram of an example process carried out by computing platform 102 for performing multiple explanation runs and using explanation scores as a basis for selecting the final explanation for a prediction is described with respect to FIG. 3B. For purposes of illustration only, example process 320 is described as being carried out by computing platform 102 of FIG. 1, but it should be understood that example process 300 may be carried out by computing platforms that take other forms as well. Further, it should be understood that, in practice, the functions described with reference to FIG. 3B may be encoded in the form of program instructions that are executable by one or more processors of computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As shown in FIG. 3B, the example process 320 may begin at block 322 with computing platform 102 performing a plurality of explanation runs, each of which results in the determination of (i) a respective candidate explanation and (ii) a corresponding explanation score. Each of these explanation runs may be performed as described above with respect to FIG. 3A.

At block 324, computing platform 102 may then use the determined explanation scores as a basis for selecting the final explanation. The function of using the explanation scores as a basis for selecting the final explanation may take various forms. As one possibility, computing platform 102 may compare the explanation scores identified in each explanation run and thereafter pick the candidate explanation having the highest explanation score. For instance, in an example, computing platform 102 may conduct a given number of explanation runs and thereafter pick the candidate explanation having the highest explanation score. Any suitable number of explanation runs are possible including, for instance, a number on the order of ten, hundreds, or thousands. More or fewer explanation runs are possible as well.

As another possibility, computing platform 102 may, after each explanation run, compare the explanation score of the newly-determined candidate explanation to the highest explanation score that was previously determined. If the explanation score of the newly-determined candidate explanation is higher than the highest explanation score that was previously determined, computing platform 102 may designate the newly-determined candidate explanation as the current “best” candidate explanation. On the other hand, if the explanation score of the newly-determined candidate explanation is not higher than the highest explanation score that was previously determined, computing platform 102 may keep the current “best” candidate explanation the same. Computing platform 102 may continue to iterate through this process until either (i) the explanation scores converge or (ii) a given number of explanation runs are carried out.

Other examples of using the explanation scores as a basis for selecting the final explanation are possible as well.

As mentioned above, the functionality that is carried out during each navigation episode of a navigation run is described in further detail with respect to FIG. 4. Computing platform 102 may perform a navigation episode during a given navigation run in various ways. A flow diagram of an example process 400 that may be carried out by computing platform 102 for performing a navigation episode during a given navigation run is described with respect to FIG. 4. For purposes of illustration only, example process 400 is described as being carried out by computing platform 102 of FIG. 1, but it should be understood that example process 400 may be carried out by computing platforms that take other forms as well. Further, it should be understood that, in practice, the functions described with reference to FIG. 4 may be encoded in the form of program instructions that are executable by one or more processors of computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As a preliminary matter, and in line with the discussion above, at the start of a given navigation episode, the navigation run will have a current state, which comprises the combination of the current values of the explanation components. At the start of the first navigation episode of a given navigation run, the current values of the explanation components may be the values represented by the root nodes of the local search spaces. Further, at the start of each subsequent navigation episode, the current values may include one value that was updated during the prior navigation episode.

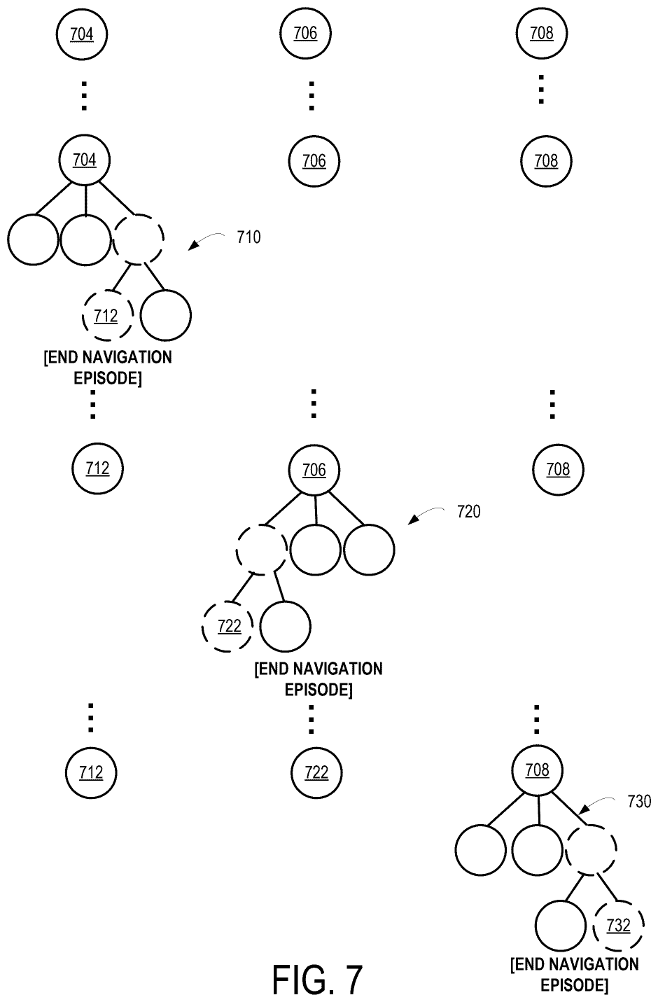

As shown in FIG. 4, process 400 may begin at block 402 with computing platform 102 selecting a given explanation component's local search space for the navigation episode. The function of selecting a given explanation component's local search space for the navigation episode may take any of various forms. As one possibility, computing platform 102 may utilize contextual bandit functionality to select a given explanation component's local search space for the navigation episode. Contextual bandit functionality may involve selecting a given explanation component's local search space for the navigation episode based on a determination of which local search space is expected to provide a higher expected reward. In this way, computing platform 102 may leverage the current values of the explanation components in order to make a more informed decision of which local search space to navigate. This contextual-bandit functionality is described in greater detail below with respect to FIG. 7.

As another possibility, computing platform 102 may select a given explanation component's local search space for the navigation episode in some other way. For example, computing platform 102 may utilize multi-armed bandit functionality to select a given explanation component's local search space for the navigation episode. As another example, computing platform 102 may randomly select a given explanation component's local search space for the navigation episode. As yet another example, computing platform 102 may select a given explanation component's local search space for the navigation episode in a sequential fashion. For instance, may iterate through a given sequence selecting the search spaces (e.g., select the downstream-feature local search space, select the subgraph local search space, and then select the nodal feature search space). Other examples of selecting a given explanation component's local search space for the navigation episode are possible as well.

However, it should be understood that in implementations where computing platform 102 selects a given explanation component's local search space for the navigation episode without using contextual bandit functionality (or some other comparable functionality that takes content into account), the computing platform 102 may need to perform more explanation runs to determine an acceptable explanation for the prediction as compared to an implementation that utilizes contextual bandit functionality to select a given explanation component's local search space for the navigation episode, because the computing platform 102 may be blind to the context in those implementations and that may inhibit the ability to converge on an acceptable explanation.

After selecting a given explanation component's local search space for the navigation episode, at block 404, computing platform 102 may identify the node within the selected local search space representing the current value of the given explanation component. This may be referred to as the “starting node” for the navigation episode. As discussed above, the starting node for a given navigation episode will depend on the current value of the given explanation component. In general, for the first navigation episode of a given local search space, the starting node may comprise the root node for the given search local space. On the other hand, for subsequent navigation episodes for that given local search space, the “starting node” may comprise the “ending node” of the previous navigation episode for that local search space, as described in further detail below.

At block 406, computing platform 102 may determine a plurality of child nodes for the starting node. Within examples, determining child nodes for the starting nodes involves removing different dimensions from the starting node, which may be referred to as “pruning actions.” As an illustrative example, and continuing the example discussed above where downstream-feature local search space 500 comprises root node 510 having five dimensions, there are five available pruning actions for the root node. More particularly, a first pruning action may involve removing feature 1, a second pruning action may involve removing feature 2, a third pruning action may involve removing feature 3, a fourth pruning action may involve removing feature 4, and a fifth pruning action may involve removing feature 5. Root nodes 530 and 550 may be pruned in a similar fashion. Further, the child nodes of local search spaces 500, 520, and 540 may also be pruned in a similar fashion. In some examples, the plurality of child nodes determined at block 406 could be all possible child nodes. In other examples, the plurality of child nodes determined at block 406 could be a subset of all possible child nodes, which is discussed in further detail below.

At block 408, computing platform 102 may determine a respective reward value for each child node in the determined plurality of child nodes. The reward value may be determined in any of various ways. As one possibility, the reward value may be equal to an importance score for the current value of the given explanation component. For example, the reward value may be a Shapley value for the current value of the given explanation component, which may be determined utilizing the functionality described above or in some other manner.

As another possibility, the reward value may be determined based on an importance score (e.g., a Shapley value) for the current value of the given explanation component and historical reward values from prior explanation runs. In this regard, computing platform 102 may keep track of historical reward values associated with candidate explanations from prior explanation runs. Further, the function of keeping track of historical reward values associated with candidate explanations from prior explanation runs may take various forms. For instance, as an example, after each explanation run, computing platform may (i) identify the reward value for the candidate explanation and (ii) assign each node in a navigation path from (a) the root node to the (b) child node associated with the candidate explanation the determined reward value. Those assigned values may be used to maintain the average historical reward values. In situations where a given child node was in one or more navigation paths for one or more prior candidate explanations, the given child node of a search space may have already been assigned a historical reward value (which may be updated with additional explanation runs to maintain an average historical reward). Thus, for a given explanation navigation run, the reward value for a given child node may be determined based on an importance score (e.g., a Shapley value) for the current value and the average historical reward for the child node. An example of how to determine the reward values based on a Shapley value for the current value and average historical reward is described below.

The function of determining a respective reward value for each child node in the determined plurality of child nodes may take other forms as well.

Referring again to FIG. 4, at block 410, computing platform 102 may select the child node having the highest respective reward value as the “winning node” from the plurality of child nodes.

In turn, at block 412, computing platform 102 may then evaluate whether a navigation budget has been reached for the given navigation episode. The navigation budget may take various forms. As one possibility, the navigation budget may be a navigation-episode depth of a given number of levels of the search tree associated with the local search space. As another possibility, the navigation budget may be a threshold number of pruning actions. As yet another possibility, the navigation budget may be a threshold amount of time for the navigation episode. Other example navigation budgets are possible as well.

At this stage of evaluating whether the navigation budget has been reached, computing platform 102 may determine either (i) the navigation budget has not been reached for the given navigation episode or (ii) the navigation budget has been reached for the given navigation episode. In this respect, if the navigation budget has not been reached for the given navigation episode, then as shown in FIG. 4 computing platform 102 may carry out another iteration of steps 406-412 using the winning node as the starting node for the next iteration. On the other hand, if the navigation budget has been reached for the given navigation episode, computing platform 102 may designate the winning node from the most-recent iteration as the “ending node” for the navigation episode and update the current value of the given explanation component to be the value represented by the ending node of the navigation episode (as shown at block 414). In practice, steps 406-412 may be carried out multiple times before the navigation budget is reached and the current value of the given explanation component is updated.

The function of performing a navigation episode during a given navigation run may take other forms as well.

As a representative example of a reward value for each child node being determined in terms of Shapley values and historical reward values and applying a navigation budget, the following example is described with respect to determining a reward value for an explanation component of the subgraph space. In this representative example, computing platform 102 may consider the knowledge graph of the seed node v in the graph-based model, i.e., [symbol] y. Further, in this representative example, navigating the subgraph search space involves conducting a Monte Carlo Tree Search (MCTS) within the subgraph space, and computing platform 102 may prune the starting node of the subgraph search space to identify a subgraph of the explanation (i.e., the downstream-feature component, subgraph, and nodal-feature component corresponding to (S′, [symbol] ′, M)). Starting with the root node, corresponding to the knowledge graph [symbol] ᵥ, computing platform 102 may build a Monte Carlo search tree [symbol] such that each node in the tree is a connected subgraph. A pruning action for [symbol] may remove a node (and all edges connected with it) from its parent node containing the subgraph [symbol] . Here, the current value of the subgraph explanation component sᵢ can be identified with a tree node [symbol] corresponding to its subgraph [symbol] . An action aⱼ removes a node (and its corresponding edges) from [symbol] ᵢ and yields the state s; corresponding to its node [symbol] and the subgraph [symbol] ⱼ. The tree policy may be given by:

$${a}^{*} = {argmax}_{{a}_{j} ∈ {A}_{i}} [ Q ( {s}_{i} , {a}_{j} ) + U ( {s}_{i} , {a}_{j} ) ] , \qquad ( Eq . 10 )$$

where [symbol] ᵢ is a set of available action at state sᵢ, and Q(sᵢ,aⱼ) denotes the empirical average reward for multiple visits in the tree where action a; is selected from state sᵢ. The term U(sᵢ,aⱼ) may be a confidence interval bound type function that controls exploration versus exploitation when the agent lacks high confidence in estimating the state-action pair value. U may be defined as:

$$U ( {s}_{i} , {a}_{j} ) = c . P ( {s}_{i} , {a}_{j} ) \cdot \frac{\sqrt{{\sum }_{{a}_{k} ∈ {A}_{i}} N ( {s}_{i} , {a}_{k} )}}{1 + N ( {s}_{i} , {a}_{j} )} , \qquad ( Eq . 11 )$$

where c is a hyperparameter that can be used to control the exploration-exploitation trade-off; P(sᵢ,aⱼ) denotes the prior probability of selecting action aⱼ from state sᵢ; and N(sᵢ,aⱼ) is the number of visit counts for playing an action aⱼ for a given state sᵢ.

Computing platform 102 may express the empirical average reward in terms of total rewards for multiple visits from a state-action pair (sᵢ,aⱼ):

$$Q ( {s}_{i} , {a}_{j} ) = \frac{w ( {s}_{i} , {a}_{j} )}{N ( {s}_{i} , {a}_{j} )} . \qquad ( Eq . 12 )$$

Each episode of the MCTS proceeds to build a portion of the search tree [symbol] with a depth [symbol] and ends the tree policy at a child node [symbol] (i.e., the ending node) in the state sₗ with the corresponding subgraph given by [symbol] .

In an example, instead of episode depth [symbol] , computing platform 102 may alternatively use the episode pruning budget [symbol] =| [symbol] |−| [symbol] |, i.e., the difference between number of nodes of the child nodes at the end of the episode i and i+1. In other words, this means that computing platform 102 may remove [symbol] nodes from the ending node of the previous navigation episode for that search space. The size of [symbol] may ultimately depend on the complexity and the size of the search space and other hyperparameters associated with the contextual bandit algorithm that allocates global pruning budgets among the three search spaces.

After each episode, where a tree depth [symbol] of [symbol] is built, the MCTS parameters are updated as follows:

$$N ( {s}_{i} , {a}_{j} ) = N ( {s}_{i} , {a}_{j} ) + 1 , \qquad ( Eq . 13 )$$

$$w ( {s}_{i} , {a}_{j} ) = w ( {s}_{i} , {a}_{j} ) + v ( {s}_{l} ) , \qquad ( Eq . 14 )$$

where [symbol] (sₜ) can be interpreted as an estimate of the reward value of the ending node after a given navigation episode ends.

In an example, computing platform 102 may define P(s,a), [symbol] (sₜ), and [symbol] (s,a) as follows:

$$P ( {s}_{i} , {a}_{j} ) = {φ}^{( {S}^{′} , {𝒢}_{j}^{′} , M )} ( {𝒢}_{j}^{′} ) , \qquad ( Eq . 15 )$$

$$v ( {s}_{l} ) = {φ}^{( {S}^{′} , {𝒢}_{l}^{′} , M )} ( {𝒢}_{l}^{′} ) , \qquad ( Eq . 16 )$$

$$w ( s , a ) = {φ}^{( {S}^{′} , {𝒢}_{l}^{′} , M )} ( {𝒢}_{l}^{′} ) . \qquad ( Eq . 17 )$$

In an example, the navigation episode may take the form of a MCTS of the search tree [symbol] , which may involve the following: taking the input of Input: ((S′)ⁱ, ( [symbol] )ⁱ, (M)ⁱ), f^{e}, f^{d}, [symbol] , ( [symbol] )ⁱ, while |( [symbol] )ⁱ|−|( [symbol] )|< [symbol] , for all possible pruning actions of [symbol] , (i) apply the action aⱼ, i.e., remove a corresponding node from [symbol] , (ii) obtain the child node [symbol] in the state sⱼ with its subgraph [symbol] ⱼ, (iii) Check if the value of P(s_{curNode},aⱼ) was computed before, and, if not, find

$$P ( {s}_{c u r N ode} , {a}_{j} ) = {φ}^{( {( {S}^{′} )}^{i} , {𝒢}_{j}^{′} , {( M )}^{i} )} ( {𝒢}_{curNode}^{′} )$$

for the action aⱼ using

$$P ( {s}_{i} , {a}_{j} ) = {φ}^{( {S}^{′} , {𝒢}_{j}^{′} , M )} ( {𝒢}_{j}^{′} ) .$$

Computing platform 102 may then record the value P(s_{curNode},aⱼ) for possible use in future episodes. Further, using the action selection

$${a}^{*} = {argmax}_{{a}_{j} ∈ {A}_{i}} [ Q ( {s}_{i} , {a}_{j} ) + U ( {s}_{i} , {a}_{j} ) ] ,$$

computing platform 102 may select the child node [symbol] update the state s_{nextState} and the search path curPath=curPath+ [symbol] . The navigation episode may end when computing platform 102 obtains the ending node [symbol] in the leaf state sₗ with the corresponding subgraph given by [symbol] . Computing platform 102 may then update the MCTS parameters using the following:

$$N ( {s}_{i} , {a}_{j} ) = N ( {s}_{i} , {a}_{j} ) + 1 , \qquad ( Eq . 18 )$$

$$w ( {s}_{i} , {a}_{j} ) = w ( {s}_{i} , {a}_{j} ) + v ( {s}_{l} ) . \qquad ( Eq . 19 )$$

It should be understood that the foregoing is a representative example for determining reward value based on an importance score for the current value of the given explanation component (e.g., a Shapley value) and historical reward values. Further, although the above is described with respect to a navigation episode for a subgraph search tree [symbol] , computing platform 102 may similarly define MCTSs for a downstream-feature search tree [symbol] and a nodal-feature search tree [symbol] .

Other examples of determining an importance score for the current value of the given explanation component (e.g., a Shapley value) and historical reward values are possible as well.

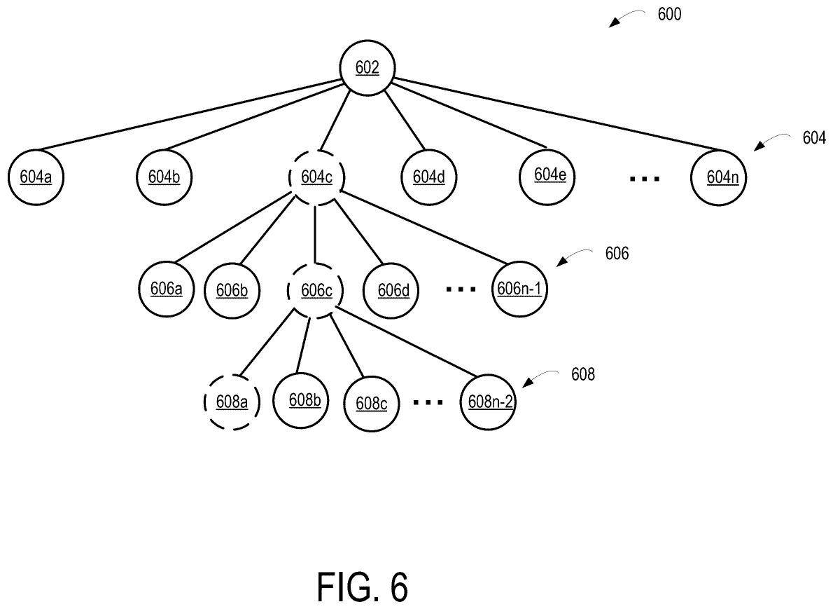

FIG. 6 depicts a visualization of a simplified example of navigation episode 600 that has a navigation budget corresponding to a navigation-episode depth of three levels. In this example, computing platform 102 may select a given local search space for the navigation episode. Computing platform 102 may identify the node 602 within the local search space representing the current value of the given explanation component. Computing platform 102 may then determine child nodes 604a-n for the starting node 602. In accordance with the discussion above regarding determination of child nodes, in some examples, the determined child nodes 604a-n may be all possible child nodes for the starting node 602, whereas, in other examples, the determined child nodes may be a subset of all the possible child nodes for the starting node 602. Computing platform 102 may determine a respective reward value for each child node in the determined plurality of child nodes 604a-n. Computing platform 102 may select the child node having the highest respective reward value as the “winning node” from the plurality of child nodes. In this example, child node 604c is selected as the “winning node.”

As mentioned above, computing platform 102 may then evaluate whether the navigation budget has been reached for the given navigation episode. In this illustrative example, the navigation budget of the navigation budget has not been reached for the given navigation episode, so computing platform may carry out another iteration of steps 406-412 using the “winning node” (i.e., child node 604c) as the starting node for this other iteration. With child node 604c as the starting node for this next iteration, computing platform 102 may then determine child nodes 606a through 606n-1 for the starting node 604c. In line with discussion above, the determined child nodes 606a through 606n-1 may be all possible child nodes for the starting node 604c, whereas, in other examples, the determined child nodes 606a through 606n-1 may be a subset of all the possible child nodes for the starting node 604c. Computing platform 102 may determine a respective reward value for each child node in the determined plurality of child nodes 606a through 606n-1. Computing platform 102 may select the child node having the highest respective reward value as the “winning node” from the plurality of child nodes. In this example, child node 606c is selected as the “winning node.”

Computing platform 102 may then once again evaluate whether the navigation budget has been reached for the given navigation episode. In this illustrative example, the navigation budget of the navigation budget has not been reached for the given navigation episode, so computing platform may carry out another iteration of steps 406-412 using the “winning node” (i.e., child node 606c) as the starting node for this other iteration. With child node 606c as the starting node for this next iteration, computing platform 102 may then determine child nodes 608a through 608n-2 for the starting node 606c. In line with discussion above, the determined child nodes 608a through 608n-2 may be all possible child nodes for the starting node 606c, whereas, in other examples, the determined child nodes 608a through 608n-2 may be a subset of all the possible child nodes for the starting node 606c. Computing platform 102 may determine a respective reward value for each child node in the determined plurality of child nodes 608a through 608n-2. Computing platform 102 may select the child node having the highest respective reward value as the “winning node” from the plurality of child nodes. In this example, child node 608a is selected as the “winning node.”

Computing platform 102 may then once again evaluate whether the navigation budget has been reached for the given navigation episode. At this stage, the navigation budget has been reached, and thus computing platform 102 may designate child node 608a as the “ending node” for the navigation episode and update the current value of the given explanation component to be the value represented by the ending node of the navigation episode.

In line with the discussion above, after the given navigation episode is completed and the current value of the given explanation component is updated, the navigation functionality may evaluate whether the updated combination of current values for the explanation components meet the explanation rule. If the updated combination of current values for the explanation components meet the explanation rule, computing platform 102 may then use the updated combination of current values for the explanation components as the candidate explanation for the navigation run. On the other hand, if the updated combination of current values for the explanation components does not meet the explanation rule, computing platform 102 may then carry out another navigation episode.

As mentioned above, each navigation episode may begin by selecting a given explanation component's local search space for the navigation episode. This selection may be referred to herein as navigating the global search space (which comprises the downstream-feature search space, the subgraph search space, and the nodal-feature search space).

An illustrative example of navigating the global search space (e.g., utilizing contextual bandit functionality) is described with reference to FIG. 7. In this example, the current value for the current value for the downstream-feature explanation component is represented by node 704, the current value for the downstream-feature explanation component is represented by node 704, and the current value for the nodal-feature explanation component is represented by node 708. Computing platform 102 may utilize the contextual bandit functionality to select the downstream-feature search space to navigate.

In this example, using the contextual bandit functionality, computing platform 102 may determine that the downstream-feature search space is the local search space expected to provide a highest expected reward (and thus that the downstream-feature search space is the most optimal local search space to be pruned at the next navigation episode). Computing platform 102 may then conduct a navigation episode 710. As discussed above, during the navigation episode 710, computing platform 102 may determine child nodes and determine reward values for the downstream-feature child nodes. Further, these reward values for the child nodes in the navigation episode may be based on the current values of the other explanation components, which correspond to nodes 706 and 708. In this example of FIG. 7, child node 712 is selected as the ending node for the navigation episode 710.

After navigation episode 710, using the contextual bandit functionality, computing platform 102 may determine that the subgraph search space is the local search space expected to provide a highest expected reward (and thus that the subgraph search space is the most optimal local search space to be pruned at the next navigation episode). Computing platform 102 may then conduct a navigation episode 720. As discussed above, during the navigation episode 720, computing platform 102 may determine child nodes and determine reward values for the subgraph child nodes. Further, these reward values for the child nodes in the navigation episode may be based on the current values of the other explanation components, which correspond to nodes 712 and 708. In this example of FIG. 7, child node 722 is selected as the ending node for the navigation episode 720.

After navigation episode 720, using the contextual bandit functionality, computing platform 102 may determine that the nodal-feature search space is the local search space expected to provide a highest expected reward (and thus that the nodal-feature search space is the most optimal local search space to be pruned at the next navigation episode. Computing platform 102 may then conduct a navigation episode 730. As discussed above, during the navigation episode 730, computing platform 102 may determine child nodes and determine reward values for the nodal-feature child nodes. Further, these reward values for the child nodes in the navigation episode may be based on the current values of the other explanation components, which correspond to nodes 712 and 722. In this example of FIG. 7, child node 732 is selected as the ending node for the navigation episode 730.

Although not shown in FIG. 7, computing platform 102 may continue this process of selecting a search space to navigate and conducting navigation episodes on the selected search space until an explanation meeting the explanation rule is obtained. Further, although FIG. 7 illustrates instances of navigating a given search space and then selecting a different search space to navigate next, it should be understood that in some examples, after navigating a given search space, the next search space selected may be the same given search space (depending on the contextual bandit functionality).

The contextual-bandit functionality may take any of various forms. For instance, in an example, the contextual-bandit functionality involves an explore-and-exploit bandit strategy. Beneficially, an explore-and-exploit bandit strategy helps to efficiently allocate pruning budgets to each local search space. The contextual bandit functionality also provides flexibility to utilize various exploration-exploitation strategies depending on possible constraints on the desired explanation.

As a representative example of an explore-and-exploit bandit strategy, computing platform 102 may assume that the arms or actions are the choice of selecting one of the three local search spaces on each episode from [symbol] , [symbol] , and [symbol] , and proceed to navigate the search spaces by building their search trees for a fixed incremental depth of [symbol] , n_{S′}, and n_{M}, respectively. Alternatively, computing platform 102 may define an episodic pruning budget (instead of an incremental depth) for [symbol] , [symbol] , and [symbol] , respectively, as [symbol] , [symbol] , and [symbol] . In some examples, the bandit algorithm may be initiated with a warm-starting strategy to address fitting oracles to scenarios with minimal data (or starting from zero, i.e., cold-start problem). At the end of each episode i, the contextual bandit algorithm Π may (i) receive the context (S′, [symbol] , M) and the corresponding reward at the end of the episode, (ii) add the event (or observation) to the history of the selected arm, (iii) updates the contextual-bandit oracle with the new history, and (iv) finally, decides that which of the three local search spaces should be navigated next.

In an example, computing platform 102 may change the contextual bandit algorithm and tailor it to accommodate the explanation rule naturally using the most appropriate bandit algorithm. For example, computing platform 102 can devise a budget-limited contextual bandit with the total budget given by:

$${N}_{( N , 𝒢 , N )}^{o} - {N}_{( {S}^{′} , {𝒢}^{′} , M )}^{min} , \qquad ( Eq . 20 )$$

where N⁰ is the total size of the knowledge graph initially, i.e., without any node pruning of the subgraph or any masking of graph or downstream features.

In this case, computing platform 102 can assign arm pulling cost (cost of selection of a particular action) relative to the current size of the explanation components as follows:

$${c}_{M} = \frac{\vert {M}^{c} \vert + \vert {S}^{′ c} \vert + \vert {𝒢}^{′} \vert}{\vert {M}^{c} \vert} \cdot {c}_{o} , \qquad ( Eq . 21 )$$

$${c}_{{S}^{′}} = \frac{\vert {M}^{c} \vert + \vert {S}^{′ c} \vert + \vert {𝒢}^{′} \vert}{\vert {S}^{′ c} \vert} \cdot {c}_{o} , \qquad ( Eq . 22 )$$

$${c}_{{𝒢}^{′}} = \frac{\vert {M}^{c} \vert + \vert {S}^{′ c} \vert + \vert {𝒢}^{′} \vert}{\vert {𝒢}^{′} \vert} \cdot {c}_{o} . \qquad ( Eq . 23 )$$

Such an arm pulling cost (cost of selection of a particular action) relative to the current size of the explanation components will encourage bandit to (i) assign a higher cost to parts of the explanation with smaller size and (ii) assign a lower cost to parts of the explanation with larger size.

It should be understood that the foregoing is a representative example for an explore-and-exploit bandit strategy that may be utilized to navigate the global search space. Other examples are possible as well.

In practice, the local search spaces may be large and complex search spaces. For instance, as mentioned above, in some examples, the root nodes of a search space may be high-dimensional nodes on the order of hundreds or thousands of dimensions. Navigating large and complex search spaces such as this may require significant computational resources. Thus, in a preferred implementation, the determined plurality of child nodes will only include a subset of possible child nodes for the starting node. This may be accomplished by imposing a limit on the number of pruning actions that are applied to the starting node during a navigation episode. For instance, in an example where all possible child nodes is 100 child nodes, computing platform 102 may sample a subset of those nodes (e.g., sample 5 nodes, 10 nodes, 15 nodes or 20 nodes, among other possibilities) by carrying out a subset of possible pruning actions on the starting node. Beneficially, sampling may help to limit the computational complexity of the navigation functionality, which may in turn help to speed up the navigation and reduce computing resources required for performing the disclosed navigation. In scenarios where sampling is utilized, only a portion of the search spaces may be evaluated during a given explanation run. However, by conducting multiple explanation runs, the disclosed interpretability technology allows for navigating different portions of the search spaces during the plurality of explanation runs, such that the final explanation is not determined solely by a single explanation run that only navigated portions of the search spaces.

As an illustrative example of sampling, referring to FIG. 6, root node 602 may comprise a large number of dimensions (e.g., 1,000 dimensions), and thus level 604 may include a large number of child nodes (e.g., 1,000 child nodes). For instance, each child node may be a node in which a respective one of the 1,000 dimensions is removed. Calculating reward values for each of the large number of nodes may involve a significant amount of computing resources (e.g., time and/or processing resources). Thus, in an example, computing platform 102 may sample a subset of those child nodes by selecting (e.g., randomly selecting) a given number of pruning actions to apply to the root node 602 and calculating reward values for each of those sampled nodes. The given number of pruning actions may be any suitable number of pruning actions. In an example, the given number of pruning actions may be a number of pruning actions falling within a range of 5 to 500 pruning actions, among other possibilities. In another example, the given number of pruning actions may be a number of pruning actions corresponding to a percentage of total dimensions of the root node. Other examples are possible as well. Computing platform 102 may then select the child node having the highest respective reward value as the “winning node” from the plurality of sampled child nodes. Computing platform 102 may then evaluate whether the navigation budget has been reached for the given navigation episode and, if the navigation budget has not been reached for the given navigation episode, carry out another iteration of sampling child nodes (using the winning node as the starting node for the next iteration). Other examples of sampling are possible as well.

As a representative example of sampling, the following describes an example of sampling various child nodes of a subgraph search space during calculating Shapley values for the subgraph explanation component (i.e., [symbol] [symbol] ). Considering the equation for computing P(sᵢ,aⱼ)= [symbol] [symbol] , computing platform 102 may sample child nodes by the following Monte Carlo sampling procedure.

First, computing platform 102 may sample a random coalition set S₂ from [symbol] { [symbol] }, where:

$${P}^{{𝒢}_{j}^{′}} = \{ {( {𝒢}_{j}^{′} )}^{M} , {\overbrace{{v}_{k + 1} , … , {v}_{m}}}^{nodes not in {𝒢}_{j}^{′}} \} . \qquad ( Eq . 24 )$$

For the sake of simplicity, the random coalition may be drawn from a particular probability distribution such that the weights in the Shapley value calculations disappear (become unit).

Computing platform 102 may then determine:

$${φ}^{( {S}^{′} , {𝒢}_{j}^{′} , M )} ( {𝒢}_{j}^{′} ) := {\sum }_{{S}_{2} ⊆ \{ {v}_{k + 1 , … , {v}_{m}} \}} 1 [ \text{} {f}^{d} \{ {x}_{{S}^{′}} , {x}_{N ∖ {S}^{′}}^{*} , {f}^{e} ( {( {G}_{j}^{′} ⋃ {S}_{2} )}^{M} ) \} - {f}^{d} \{ {x}_{{S}^{′}} , {x}_{N ∖ {S}^{′}}^{*} , {f}^{e} ( {( {S}_{2} )}^{M} ) \} ] . \qquad ( Eq . 25 )$$

Computing platform 102 may then take the average for T Monte-Carlo sampling steps:

$$\frac{1}{T} {\sum }_{t = 1}^{T} {φ}^{( {S}^{′} , {𝒢}_{j}^{′} , M )} ( {𝒢}_{j}^{′} ) . \qquad ( Eq . 26 )$$

It should be understood that the foregoing is a representative example for sampling various child nodes of a subgraph search space during calculating Shapley values for the subgraph explanation component. Further, although this example is described with respect to sampling the subgraph search space during a navigation episode, similar Monte-Carlo sampling may be applied to [symbol] (S′) and [symbol] (M).

As mentioned above, after determining the explanation, computing platform 102 causes the determined explanation to be outputted. For instance, computing platform 102 may transmit, to a consumer system 106, data defining the explanation and thereby cause an indication of the explanation to be presented at a user interface of the consumer system. The output may take various forms, and an example output taking the form of a presentation of the set of features associated with the determined explanation is illustrated in FIG. 8. In particular, FIG. 8 depicts an example snapshot 800 of a graphical user interface (GUI) 802 that displays an indication 804 of the set of features associated with the determined explanation. In this example, the indication 804 comprises a plurality of indicators for the three explanation components, including an indicator 806 for the downstream feature set, an indicator 808 for the subgraph, and an indicator 810 for the nodal feature set. Other examples are possible as well.

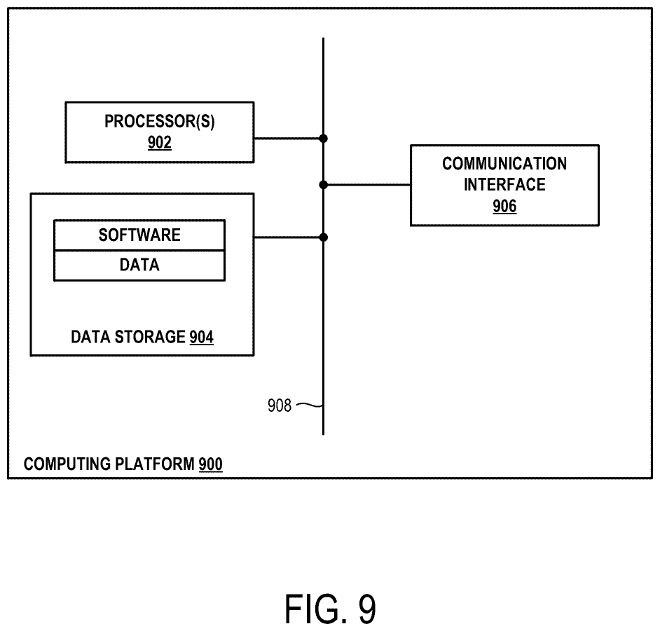

Turning now to FIG. 9, a simplified block diagram is provided to illustrate some structural components that may be included in an example computing platform 900, which may be configured to host and execute the new software technology disclosed herein. As shown in FIG. 9, the example computing platform 900 may include at least a processor 902, data storage 904, and a communication interface 906, all of which may be communicatively linked by a communication link 908 that may take the form of a system bus, a communication network such as a public, private, or hybrid cloud, or some other connection mechanism.

Processor 902 may comprise one or more processing components, such as general-purpose processors (e.g., a single- or multi-core CPU), special-purpose processors (e.g., a GPU, application-specific integrated circuit (ASIC), or digital-signal processor (DSP)), programmable logic devices (e.g., a field programmable gate array), controllers (e.g., microcontrollers), and/or any other processor components now known or later developed. In line with the discussion above, it should also be understood that processor 902 could comprise processing components that are distributed across a plurality of physical computing devices connected via a network, such as a computing cluster of a public, private, or hybrid cloud.

In turn, data storage 904 may comprise one or more non-transitory computer-readable storage mediums that are collectively configured to store (i) program instructions that are executable by processor 902 such that the computing platform 900 is configured to perform any of the various functions disclosed herein (including but not limited to any the functions described above with reference to FIGS. 3A-4), and (ii) data that may be received, derived, or otherwise stored, for example, in one or more databases, file systems, repositories, or the like, by computing platform 900. In this respect, the one or more non-transitory computer-readable storage mediums of data storage 904 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 904 may comprise computer-readable storage mediums that are distributed across a plurality of physical computing devices connected via a network, such as a storage cluster of a public, private, or hybrid cloud. Data storage 904 may take other forms and/or store data in other manners as well.

Communication interface 906 may be configured to facilitate wireless and/or wired communication with client stations (e.g., one or more client devices 106 of FIG. 1) and/or third-party computing platforms. Additionally, in an implementation where the computing platform 900 comprises a plurality of physical computing devices connected via a network, communication interface 906 may be configured to facilitate wireless and/or wired communication between these physical computing devices (e.g., between computing and storage clusters in a cloud network). As such, communication interface 906 may take any suitable form for carrying out these functions, examples of which may include an Ethernet interface, a Wi-Fi network, a cellular network, a serial bus interface (e.g., Firewire, USB 3.0, etc.), a chipset and antenna adapted to facilitate wireless communication, short-range wireless protocols, one or more APIs and/or an API gateway, and/or any other interface that provides for wireless and/or wired communication. Communication interface 906 may also include multiple communication interfaces of different types. Other configurations are possible as well.

Although not shown, the computing platform 900 may additionally include or have an interface for connecting to user-interface components that facilitate user interaction with computing platform 900, such as a keyboard, a mouse, a trackpad, a display screen, a touch-sensitive interface, a stylus, a virtual-reality headset, and/or speakers, among other possibilities.

It should be understood that the computing platform 900 is one example of a computing platform that may be used with the embodiments described herein. Numerous other arrangements are possible and contemplated herein. For instance, in other embodiments, the computing platform 900 may include additional components not pictured and/or more or fewer of the pictured components.

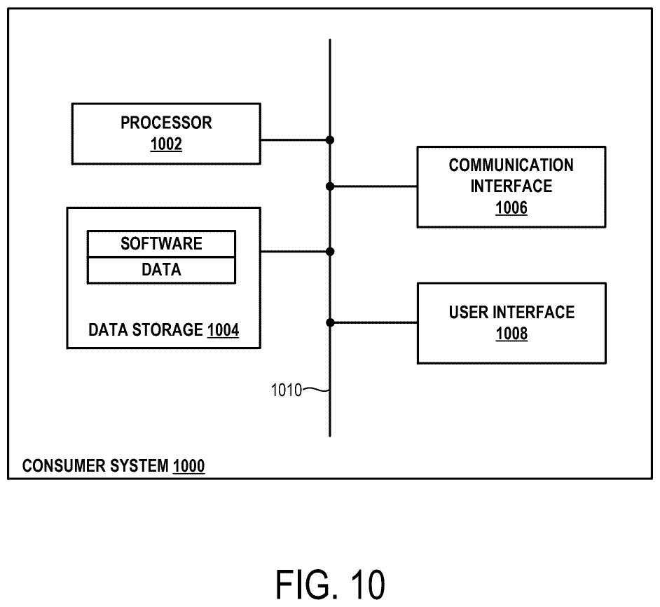

Turning next to FIG. 10, a simplified block diagram is provided to illustrate some structural components that may be included in an example consumer system 1000 that may access and communicate with a computing platform that is configured to host and execute the new software technology disclosed herein, such as the computing platform 102 of FIG. 1. As shown in FIG. 10, the consumer system 1000 may include at least a processor 1002, data storage 1004, a communication interface 1006, and a user interface 1008, all of which may be communicatively linked by a communication link 1010 that may take the form of a system bus, a communication network such as a public, private, or hybrid cloud, or some other connection mechanism.

Processor 1002 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed. In line with the discussion above, it should also be understood that processor 1002 could comprise processing components that are distributed across a plurality of physical computing devices connected via a network, such as a computing cluster of a public, private, or hybrid cloud.

In turn, data storage 1004 may comprise one or more non-transitory computer-readable storage mediums that are collectively configured to store (i) program instructions that are executable by processor 1002 such that the consumer system 1000 is configured to perform certain functions related to interacting with and accessing services provided by a computing platform, and (ii) data that may be received, derived, or otherwise stored, for example, in one or more databases, file systems, repositories, or the like, by the consumer system 1000, related to interacting with and accessing services provided by a computing platform. In this respect, the one or more non-transitory computer-readable storage mediums of data storage 1004 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 1004 may comprise computer-readable storage mediums that are distributed across a plurality of physical computing devices connected via a network, such as a storage cluster of a public, private, or hybrid cloud. Data storage 1004 may take other forms and/or store data in other manners as well.

Communication interface 1006 may be configured to facilitate wireless and/or wired communication with other computing devices. Communication interface 1006 may take any of various forms, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

The consumer system 1000 may additionally include a user interface 1008 for connecting to one or more user-interface components that facilitate user interaction with the consumer system 1000, such as a keyboard, a mouse, a trackpad, a display screen, a touch-sensitive interface, a stylus, a virtual-reality headset, and/or one or more speaker components, among other possibilities.

It should be understood that the consumer system 1000 is one example of a consumer system that may be used to interact with an example computing platform as described herein. Numerous other arrangements are possible and contemplated herein. For instance, in other embodiments, the consumer system 1000 may include additional components not pictured and/or more or fewer of the pictured components.

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
a communication interface;
at least one processor;
at least one non-transitory computer-readable medium; and
program instructions stored on the at least one non-transitory computer-readable medium that, when executed by the at least one processor, cause the computing platform to:
perform a plurality of explanation runs for explaining a prediction rendered by a machine learning model that is configured to receive, as input, (i) an embedding produced by a graph-based model based on a data graph comprising nodes interconnected by edges, wherein the nodes are associated with values for a set of nodal features, and (ii) a set of model features, wherein each explanation run involves:
(i) identifying (a) a first local search space for a model-feature explanation component that identifies a subset of the set of model features, (b) a second local search space for a subgraph explanation component that identifies a subgraph of the data graph, and (c) a third local search space for a nodal-feature explanation component that identifies a subset of the set of nodal features;
(ii) navigating the first, second, and third local search spaces to determine a respective candidate explanation that satisfies an explanation rule, wherein the respective candidate explanation comprises (a) a respective subset of the set of model features, (b) a respective subgraph of the data graph, and (c) a respective subset of the set of nodal features; and
(iii) determining a respective explanation score for the respective candidate explanation;
based on the respective explanation scores for the respective candidate explanations, determine a given explanation for the prediction comprising a given subset of the set of model features, a given subgraph of the data graph, and a given subset of the set of nodal features; and
transmit, to a consumer system, data defining the given explanation and thereby cause an indication of the given explanation to be presented at a user interface of the consumer system.

2. The computing platform of claim 1, wherein the explanation rule limits a size of an explanation for the prediction.

3. The computing platform of claim 1, wherein navigating the first, second, and third local search spaces to determine the respective candidate explanation that satisfies the explanation rule comprises performing a plurality of navigation episodes, wherein each navigation episode comprises the steps of:
(i) selecting a given local search space for the navigation episode from the first, second, and third local search spaces, wherein the given local search space corresponds to a given explanation component from the model-feature explanation component, the subgraph explanation component, and the nodal-feature explanation component;
(ii) identifying a node within the given local search space representing a current value of the given explanation component and designating the node as a starting node;
(iii) determining a plurality of child nodes for the starting node;
(iv) determining a respective reward value for each child node in the determined plurality of child nodes;
(v) selecting the child node having a highest respective reward value as a winning node from the plurality of child nodes;
(vi) evaluating whether a navigation budget has been reached for the given navigation episode; and
(vii) based on the evaluating, either:
determining that the navigation budget has not been reached for the navigation episode and then carrying out a next iteration of steps (iii)-(vi) using the winning node as a starting node for the next iteration, or
determining that the navigation budget has been reached for the navigation episode and then designating the winning node from the most-recent iteration as an ending node for the navigation episode and updating the current value of the given explanation component to be the value represented by the ending node of the navigation episode.

4. The computing platform of claim 3, wherein the navigation budget is a navigation-episode depth of a given number of levels of a Monte Carlo search tree associated with the local search space.

5. The computing platform of claim 3, wherein selecting the given local search space for the navigation episode comprises selecting the given local search space for the navigation episode based on a determination of which of the first, second, and third local search spaces is expected to provide a higher expected reward.

6. The computing platform of claim 3, wherein determining the plurality of child nodes for the starting node comprises sampling a subset of all possible child nodes for the starting node to determine the plurality of child nodes.

7. The computing platform of claim 1, wherein determining the respective explanation score for the respective candidate explanation comprises determining the respective explanation score based on (i) a first importance score determined for the model-feature explanation component, (ii) a second importance score determined for the subgraph explanation component, and (iii) a third importance score determined for the nodal-feature explanation component.

8. The computing platform of claim 7, wherein:
the first importance score determined for the model-feature explanation component comprises a first Shapley value for the model-feature explanation component;
the second importance score determined for the subgraph explanation component comprises a second Shapley value for the subgraph explanation component; and
the third importance score determined for the nodal-feature explanation component comprises a third Shapley value for the nodal-feature explanation component.

9. A non-transitory computer-readable medium, wherein the non-transitory computer-readable medium is provisioned with program instructions that, when executed by at least one processor, cause a computing platform to:
perform a plurality of explanation runs for explaining a prediction rendered by a machine learning model that is configured to receive, as input, (i) an embedding produced by a graph-based model based on a data graph comprising nodes interconnected by edges, wherein the nodes are associated with values for a set of nodal features, and (ii) a set of model features, wherein each explanation run involves:
(i) identifying (a) a first local search space for a model-feature explanation component that identifies a subset of the set of model features, (b) a second local search space for a subgraph explanation component that identifies a subgraph of the data graph, and (c) a third local search space for a nodal-feature explanation component that identifies a subset of the set of nodal features;
(ii) navigating the first, second, and third local search spaces to determine a respective candidate explanation that satisfies an explanation rule, wherein the respective candidate explanation comprises (a) a respective subset of the set of model features, (b) a respective subgraph of the data graph, and (c) a respective subset of the set of nodal features; and
(iii) determining a respective explanation score for the respective candidate explanation;
based on the respective explanation scores for the respective candidate explanations, determine a given explanation for the prediction comprising a given subset of the set of model features, a given subgraph of the data graph, and a given subset of the set of nodal features; and
transmit, to a consumer system, data defining the given explanation and thereby cause an indication of the given explanation to be presented at a user interface of the consumer system.

10. The non-transitory computer-readable medium of claim 9, wherein the explanation rule limits a size of an explanation for the prediction.

11. The non-transitory computer-readable medium of claim 9, wherein navigating the first, second, and third local search spaces to determine the respective candidate explanation that satisfies the explanation rule comprises performing a plurality of navigation episodes, wherein each navigation episode comprises the steps of:
(i) selecting a given local search space for the navigation episode from the first, second, and third local search spaces, wherein the given local search space corresponds to a given explanation component from the model-feature explanation component, the subgraph explanation component, and the nodal-feature explanation component;
(ii) identifying a node within the given local search space representing a current value of the given explanation component and designating the node as a starting node;
(iii) determining a plurality of child nodes for the starting node;
(iv) determining a respective reward value for each child node in the determined plurality of child nodes;
(v) selecting the child node having a highest respective reward value as a winning node from the plurality of child nodes;
(vi) evaluating whether a navigation budget has been reached for the given navigation episode; and
(vii) based on the evaluating, either:
determining that the navigation budget has not been reached for the navigation episode and then carrying out a next iteration of steps (iii)-(vi) using the winning node as a starting node for the next iteration, or
determining that the navigation budget has been reached for the navigation episode and then designating the winning node from the most-recent iteration as an ending node for the navigation episode and updating the current value of the given explanation component to be the value represented by the ending node of the navigation episode.

12. The non-transitory computer-readable medium of claim 11, wherein the navigation budget is a navigation-episode depth of a given number of levels of a Monte Carlo search tree associated with the local search space.

13. The non-transitory computer-readable medium of claim 11, wherein selecting the given local search space for the navigation episode comprises selecting the given local search space for the navigation episode based on a determination of which of the first, second, and third local search spaces is expected to provide a higher expected reward.

14. The non-transitory computer-readable medium of claim 11, wherein determining the plurality of child nodes for the starting node comprises sampling a subset of all possible child nodes for the starting node to determine the plurality of child nodes.

15. The non-transitory computer-readable medium of claim 9, wherein determining the respective explanation score for the respective candidate explanation comprises determining the respective explanation score based on (i) a first importance score determined for the model-feature explanation component, (ii) a second importance score determined for the subgraph explanation component, and (iii) a third importance score determined for the nodal-feature explanation component.

16. The non-transitory computer-readable medium of claim 15, wherein:
the first importance score determined for the model-feature explanation component comprises a first Shapley value for the model-feature explanation component;
the second importance score determined for the subgraph explanation component comprises a second Shapley value for the subgraph explanation component; and
the third importance score determined for the nodal-feature explanation component comprises a third Shapley value for the nodal-feature explanation component.

17. A method carried out by a computing platform, the method comprising:
performing a plurality of explanation runs for explaining a prediction rendered by a machine learning model that is configured to receive, as input, (i) an embedding produced by a graph-based model based on a data graph comprising nodes interconnected by edges, wherein the nodes are associated with values for a set of nodal features, and (ii) a set of model features, wherein each explanation run involves:
(i) identifying (a) a first local search space for a model-feature explanation component that identifies a subset of the set of model features, (b) a second local search space for a subgraph explanation component that identifies a subgraph of the data graph, and (c) a third local search space for a nodal-feature explanation component that identifies a subset of the set of nodal features;
(ii) navigating the first, second, and third local search spaces to determine a respective candidate explanation that satisfies an explanation rule, wherein the respective candidate explanation comprises (a) a respective subset of the set of model features, (b) a respective subgraph of the data graph, and (c) a respective subset of the set of nodal features; and
(iii) determining a respective explanation score for the respective candidate explanation;
based on the respective explanation scores for the respective candidate explanations, determining a given explanation for the prediction comprising a given subset of the set of model features, a given subgraph of the data graph, and a given subset of the set of nodal features; and
transmitting, to a consumer system, data defining the given explanation and thereby causing an indication of the given explanation to be presented at a user interface of the consumer system.

18. The method of claim 17, wherein navigating the first, second, and third local search spaces to determine the respective candidate explanation that satisfies the explanation rule comprises performing a plurality of navigation episodes, wherein each navigation episode comprises the steps of:
(i) selecting a given local search space for the navigation episode from the first, second, and third local search spaces, wherein the given local search space corresponds to a given explanation component from the model-feature explanation component, the subgraph explanation component, and the nodal-feature explanation component;
(ii) identifying a node within the given local search space representing a current value of the given explanation component and designating the node as a starting node;
(iii) determining a plurality of child nodes for the starting node;
(iv) determining a respective reward value for each child node in the determined plurality of child nodes;
(v) selecting the child node having a highest respective reward value as a winning node from the plurality of child nodes;
(vi) evaluating whether a navigation budget has been reached for the given navigation episode; and
(vii) based on the evaluating, either:
determining that the navigation budget has not been reached for the navigation episode and then carrying out a next iteration of steps (iii)-(vi) using the winning node as a starting node for the next iteration, or
determining that the navigation budget has been reached for the navigation episode and then designating the winning node from the most-recent iteration as an ending node for the navigation episode and updating the current value of the given explanation component to be the value represented by the ending node of the navigation episode.

19. The method of claim 18, wherein selecting the given local search space for the navigation episode comprises selecting the given local search space for the navigation episode based on a determination of which of the first, second, and third local search spaces is expected to provide a higher expected reward.

20. The method of claim 18, wherein determining the plurality of child nodes for the starting node comprises sampling a subset of all possible child nodes for the starting node to determine the plurality of child nodes.
